(19) United States
(12) Patent Application Publication
(10) Pub. No.: US 2026/0368663 A1
(43) Pub. Date: Nov. 19, 2026

(54) SYSTEMS AND METHODS FOR PROGRESSIVE ACTIVATION OF A MODULAR SUITE

(71) Applicant: The Strategic Coach Inc., Toronto (CA)

(72) Inventors: Barbara Sue Smith, Toronto (CA); Daniel J. Sullivan, Toronto (CA)

(73) Assignee: The Strategic Coach Inc., Toronto (CA)

(21) Appl. No.: 19/184,105

(22) Filed: Apr. 21, 2025

(51) Int. Cl. G06Q 10/0631; G06Q 10/0637; G06Q 10/0639; G06Q 30/0202

(52) U.S. Cl. CPC G06Q 10/06313; G06Q 10/0637; G06Q 10/0639; G06Q 30/0202

(57) ABSTRACT

A system for progressive activation of a modular suite including a user interface configured to receive user input, at least a processor, and a memory communicatively connected to the at least a processor and containing instructions configuring the at least a processor to receive, at the user interface, an entity profile comprising at least an environment selection and a target function, generate a policy, comprising a set of steps, as a function of the environment selection and target function, and progressively activate one or more modules of the modular suite as a function of a predetermined progression schedule, wherein a first module is configured to determine a resource distribution, a second module is configured to determine a growth factor, and a third module is configured to generate exploitation data.

### FIELD OF THE INVENTION

The present invention generally relates to the field of intelligent control systems and adaptive modular architectures. In particular, the present invention is directed to systems and methods for progressive activation of a modular suite.

### BACKGROUND

Conventional educational training systems often suffer from fragmented architectures that manage resource allocation, growth development, and collaboration opportunities in isolation. These systems typically follow static activation sequences, limiting their ability to respond dynamically to learner performance or shifting contextual needs. Moreover, they fail to integrate historical and real-time data in a meaningful way, preventing adaptive decision-making that could enhance individual and collective outcomes. As a result, problems such as persistent gaps in support, stagnated learner development, and overlooked opportunities for external collaboration and impact may be faced.

### SUMMARY OF THE DISCLOSURE

In an aspect, a system for progressive activation of a modular suite may include a user interface configured to receive user input, at least a processor, and a memory communicatively connected to the at least a processor and containing instructions configuring the at least a processor to receive, at the user interface, an entity profile comprising at least an environment selection and a target function, generate a policy, comprising a set of steps, as a function of the environment selection and target function, and progressively activate one or more modules of the modular suite as a function of a predetermined progression schedule, wherein a first module is configured to determine a resource distribution, a second module is configured to determine a growth factor, and a third module is configured to generate exploitation data. Determining a resource distribution may include identifying a plurality of resource data as a function of the entity profile, determining apportionment data associated with the plurality of function data as a function of the plurality of resources, generating optimized apportionment data as a function of the apportionment data and the plurality of resource data, wherein generating optimized apportionment data includes identifying at least one constraint associated with the apportionment data using a constraint machine-learning model that has been trained on a dataset including apportionment data correlated to historical constraints, and determining a resource distribution as a function of the optimized apportionment data. Determining a growth factor may include receiving the resource distribution from the first module and determining a growth constraint profile including at least one characteristic affecting a growth ability of the entity and a temporal element. Generating exploitation data may include receiving a plurality of entity profiles, each including operational data, identifying demand data as a function of the entity profiles, generating exploitation data as a function of the operational data and the demand data of the plurality of entity profiles, and determining collaboration data as a function of the exploitation data.

In another aspect, a method for progressive activation of a modular suite may include receiving, at a user interface, an entity profile including at least an environment selection and a target function, generating a policy, comprising a set of steps, as a function of the environment selection and target function, progressively activating one or more modules of the modular suite as a function of a predetermined progression schedule, wherein a first module is configured to determine a resource distribution, a second module is configured to determine a growth factor, and a third module is configured to generate exploitation data. Determining a resource distribution may include identifying a plurality of resource data as a function of the entity profile, determining apportionment data associated with the plurality of function data as a function of the plurality of resources, generating optimized apportionment data as a function of the apportionment data and the plurality of resource data, wherein generating optimized apportionment data includes identifying at least one constraint associated with the apportionment data using a constraint machine-learning model that has been trained on a dataset including apportionment data correlated to historical constraints, and determining a resource distribution as a function of the optimized apportionment data. Determining a growth factor may include receiving the resource distribution from the first module and determining a growth constraint profile including at least one characteristic affecting a growth ability of the entity and a temporal element. Generating exploitation data may include receiving a plurality of entity profiles, each including operational data, identifying demand data as a function of the entity profiles, generating exploitation data as a function of the operational data and the demand data of the plurality of entity profiles, and determining collaboration data as a function of the exploitation data.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary system for progressive activation of a modular suite;

FIG. 2 is an illustrative embodiment of a user interface;

FIG. 3 is a block diagram of an exemplary embodiment of a machine learning model;

FIG. 4 is a schematic diagram of an exemplary embodiment of a neural network;

FIG. 5 is a schematic diagram of an exemplary embodiment of a neural network node;

FIG. 6 is an illustration of an exemplary embodiment of a fuzzy set comparison;

FIG. 7 is an illustration of an exemplary embodiment of a chatbot;

FIG. 8 is a flow diagram depicting an exemplary embodiment of a method for progressive activation of a modular suite; and

FIG. 9 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for progressive activation of a modular suite of software components. In an embodiment, the system may receive an entity profile, including an environment selection and a target function, and generate an operational policy that is iteratively refined based on captured time-series data.

Aspects of the present disclosure can be used to dynamically adjust system configurations in real time. Aspects of the present disclosure can also be used to provide comparative analytics and technical recommendations to optimize module activation and performance. This is so, at least in part, because the system leverages an adaptive refinement model, such as a neural network with input, hidden, and output layers, to continuously update the policy based on both internal and externally sourced data.

Aspects of the present disclosure allow for scalable, data-driven system optimization that evolves in response to continuously monitored performance metrics. Exemplary embodiments illustrating aspects of the present disclosure are described below in the context of several specific examples.

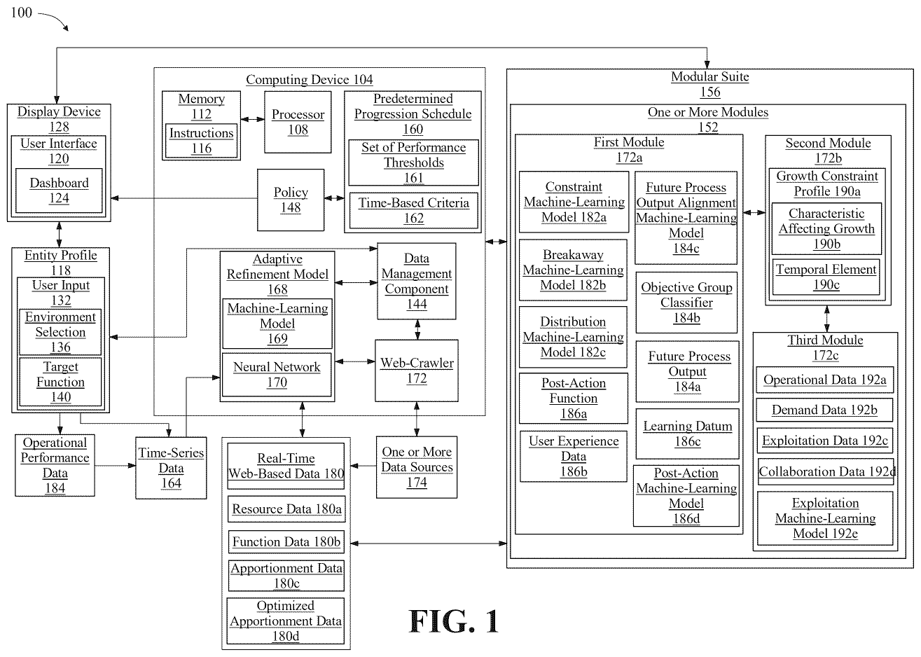

Referring now to FIG. 1, an exemplary embodiment of a system 100 for progressive activation of a modular suite 156 is illustrated. In an embodiment, system 100 includes a user interface 120 configured to receive an entity profile 118. For the purposes of this disclosure, an “entity profile” is a data structure representing an entity. An entity profile 118 may be made up of a plurality of entity data. As used in the current disclosure, “entity data” is information associated with the entity. For example, entity data may include an environment of operation, target functions 140 or data related to generating a target function 140, resource data 180a, operational data 192a, and/or the like. As used in the current disclosure, an “entity” is an organization comprised of one or more persons with a specific purpose. An entity may include a corporation, organization, business, group, and the like. An entity profile 118 may be created by at least a processor 108, a user, or a third party. As used in the current disclosure, a “user” is a figure within the entity. The user may include a manager, owner, or shareholder of the entity. The entity profile 118 may further include information regarding the entity's revenue, gross income, net income, business debts, a list of business expenses, current inventory, inventory history, sales information, human resource information, employee information, employee salaries, timecards, a list of company assets, a list of capital projects, accounting information, and the like.

With continued reference to FIG. 1, entity profile 118 may include function data 180b. As used in the current disclosure, “function data” is data associated with an action performed by a member affiliated with an entity for the furtherance of the purpose of the entity. As used in the current disclosure, a “function” is a task or action performed by an affiliated member of an entity for the furtherance of the purpose of the entity. Function data 180b may include employee function data 180b, owner function data 180b, manager function data 180b, and the like. For example, function data 180b may describe the responsibilities of an employee, manager, or owner. Function data 180b may, in some cases, represent internal or external tasks as they relate to the entity. Examples of function data 180b may include, but are not limited to data describing managerial responsibilities, providing a service, making goods, maintaining a facility, interfacing with clients, accounting activities, product selection, ordering inventory, hiring and/or firing of employees, employee management, resource management, assigning tasks, and the like. Function data 180b may additionally be organized by time. In a non-limiting example, function data 180b of an employee may include facility maintenance, preparing goods, and organizing the goods once they are prepared. In another non-limiting example, an entity may have to accomplish the following task in a given day: provide 10 customers with a service, interface with clients, prepare goods, and store goods within a working day. Function data 180b may describe all of the tasks and sub-tasks associated with the entity model. Function data 180b may be entered into at least a processor 108 by a user. In some embodiments, at least a processor 108 may additionally be configured to generate a list of functions based on the purpose of the entity, job descriptions of the employee, the number of goods promised, the number of services to be provided, and the like. This may be accomplished, in some cases, by using a machine-learning model or fuzzy inference set.

With further reference to FIG. 1, in some cases, an entity profile 118 may include user input 132, which may be entered at user interface 120. For example, and without limitation, a user or a third party may manually input entity profile 118 using a graphical user interface of processor 108 or a remote device, such as for example, a smartphone or laptop. For purposes of this disclosure, a “user interface” is the space where interactions between a user and the machines occur. User interface 120 (UI) may encompass elements, such as screens, buttons, icons, menus, and gestures, that allow users to control a device or software application, making the technology both functional and user-friendly. There are several types of user interfaces, each with its own methods of interaction. Graphical User Interfaces (GUIs) may use visual elements like windows, icons, and buttons, allowing users to interact with software through direct manipulation, while Command-Line Interfaces (CLIs) may rely on text-based commands where users type instructions to perform operations. Additionally, Voice User Interfaces (VUIs) enable interaction through voice commands, which may be used in virtual assistants and smart devices, and touch interfaces, common on smartphones and tablets, rely on gestures like swiping and tapping. The design of a UI 120 may be critical because it directly affects usability, user satisfaction, and the overall effectiveness of system 100.

In continued reference to FIG. 1, in an embodiment, entity profile 118 may additionally be generated using a user's answers to a series of questions. In an embodiment, the series of questions may be implemented using a chatbot, as described herein in further detail below. A chatbot may be configured to generate questions regarding various elements of entity profile 118. In a non-limiting embodiment, a user may be prompted to input specific information or may be prompted to fill out a questionnaire. In an embodiment, a graphical user interface may display a series of questions to prompt a user for information pertaining to entity profile 118. The entity profile 118 may be transmitted to at least a processor 108, such as by wired or wireless communication. In an embodiment, entity profile 118 may be retrieved from multiple sources, including third-party sources. For example, this may include the user's inventory records, financial records, human resource records, past entity profiles 118, sales records, user notes and observations, job descriptions, and the like. Generating entity profile 118 may include various encryption processes for security purposes.

With continued reference to FIG. 1, in an embodiment, entity profile 118 may include entity records. As used in the current disclosure, an “entity record” is a document that contains information regarding the entity. Entity records may include employee credentials, reports, financial records, medical records, business records, Asset inventory, sales history, sales predictions, and government records (i.e. birth certificates, social security cards, and the like). An entity record may additionally include an employee record. An employee record may include information such as employee evaluations, human resource records, client files, invoices, time cards, driver's license databases, news articles, social media profiles and/or posts, and the like. In some cases, entity records may be identified using a web crawler. Entity records may include a variety of types of “notes” entered over time by the user, employees of the user, support staff, advisors, and the like. Further, in an embodiment, entity records that are not already formatted in a machine readable format may be converted into machine-encoded text using an optical character reader (OCR).

Still referring to FIG. 1, in some embodiments, optical character recognition or optical character reader (OCR) includes the automatic conversion of images of written (e.g., typed, handwritten, or printed text) into machine-encoded text. In some cases, recognition of at least a keyword from an image component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes.

Still referring to FIG. 1, in some cases, OCR may be an “offline” process, which analyses a static document or image frame. In some cases, handwriting movement analysis can be used as input for handwriting recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

Still referring to FIG. 1, in some cases, OCR processes may employ pre-processing of image components. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to the image component to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from the background of the image component. In some cases, binarization may be required for example if an employed OCR algorithm only works on binary images. In some cases, a line removal process may include the removal of non glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify a script allowing an appropriate OCR algorithm to be selected. In some cases, a character isolation or “segmentation” process may separate signal characters, for example, character-based OCR algorithms. In some cases, a normalization process may normalize the aspect ratio and/or scale of the image component.

Still referring to FIG. 1, in some embodiments, an OCR process may include an OCR algorithm. Exemplary OCR algorithms may include matrix-matching process and/or feature extraction processes. Matrix matching may involve comparing an image to a stored glyph on a pixel-by-pixel basis. In some cases, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at the same scale as input glyph. Matrix matching may work best with typewritten text.

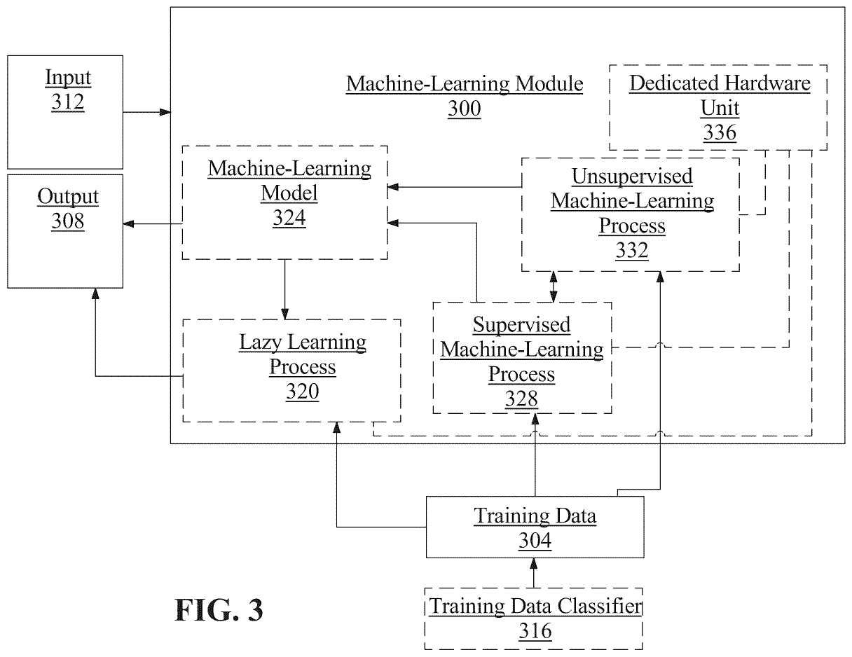

Still referring to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted feature can be compared with an abstract vector-like representation of a character, which might reduce to one or more glyph prototypes. General techniques of feature detection in computer vision are applicable to this type of OCR. In some embodiments, machine-learning process like nearest neighbor classifiers (e.g., k-nearest neighbors algorithm) can be used to compare image features with stored glyph features and choose a nearest match. OCR may employ any machine learning process described in this disclosure, for example machine-learning processes described with reference to FIGS. 3-5. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

Still referring to FIG. 1, in some cases, OCR may employ a two-pass approach to character recognition. The second pass may include adaptive recognition and use letter shapes recognized with high confidence on a first pass to recognize more suitable fit remaining letters on the second pass. In some cases, two-pass approach may be advantageous for unusual fonts or low-quality image components where visual verbal content may be distorted. Another exemplary OCR software tool may include OCRopus. OCRopus development which is led by German Research Centre for Artificial Intelligence in Kaiserslautern, Germany. In some cases, OCR software may employ neural networks, for example neural networks as taught in reference to FIGS. 3-5.

Still referring to FIG. 1, in some cases, OCR may include post-processing. For example, OCR accuracy may be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near neighbor analysis can make use of co-occurrence frequencies to correct errors, by noting that certain words are often seen together. For example, “Washington, D.C.” is generally far more common in English than “Washington DOC.” In some cases, an OCR process may make use of a priori knowledge of grammar for a language to be recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

With continued reference to FIG. 1, entity profile 118 may be, at least partially, generated using a web crawler. A “web crawler,” as used herein, is a program that systematically browses the internet for the purpose of Web indexing. The web crawler may be seeded with platform URLs, wherein the crawler may then visit the next related URL, retrieve the content, index the content, and/or measures the relevance of the content to the topic of interest. In some embodiments, at least a processor 108 may generate a web crawler to compile the entity profile 118 and entity data. The web crawler may be seeded and/or trained with a reputable website, such as the user's business website, to begin the search. A web crawler may be generated by at least a processor 108. In some embodiments, the web crawler may be trained with information received from a user through a user interface. In some embodiments, the web crawler may be configured to generate a web query. A web query may include search criteria received from a user. For example, a user may submit a plurality of websites for the web crawler to search to extract entity records, inventory records, financial records, human resource records, past entity profiles 118, sales records, user notes, and observations, based on criteria such as a time, location, and the like.

Continuing to refer to FIG. 1, in an embodiment, at least a processor 108 may be configured to generate personnel data as a function of entity profile 118. As used in the current disclosure, “personnel data” is an element of data related to the personnel of the entity. Personnel data may be received from a personnel database. Personnel data may include a list of all employees associated with an entity. Personnel data may additionally include a listing of all of the credentials and experience associated with the employees. Personnel data may include a listing of functions that are completed by an employee, this may also include completion times associated with those functions. In embodiments, determining personnel data may include an identification of current roles associated with the employee. A “current role,” as used herein, is an aggregate of functions that an employee performs regularly. In a non-limiting example, the current role may include yard landscaping, which may include tasks such as raking, lawn mowing, and the like. In another non-limiting example, the current role may include a dog walker, which may include tasks such as walking dogs, picking up dogs from the user's residence and returning them, bringing a user's dog to the dog park, and the like. Associations between function data 180b and current roles may be performed using a machine learning model. Associations between functions and current roles may be performed using any algorithm and/or methodology described in reference to the entirety of this disclosure. It will become apparent to a person of ordinary skill in the art, upon reading this disclosure, the many tasks that may be associated with roles and that two or more roles may have overlapping tasks associated with them.

With continued reference to FIG. 1, in an embodiment, entity profile 118 may include an entity process. In some cases, at least a processor may be configured to identify entity process. As used in this disclosure, an “entity process” is a series of steps an entity performs to produce a desired product. In some embodiments, entity process may include multiple steps performed by multiple third-party sources. As a non-limiting example, entity process may include a prototyping step, a manufacturing step, and a selling step. Each of the three steps may be performed by distinct, third party sources. In some embodiments, each step of the entity process may be performed by entity themselves. In some instances, entity performing entity process may reduce financial and time considerations associated with performing entity process. In some embodiments, determining growth factor may include comparing financial and time considerations for each step of entity process to industry standard as a function of various parameters. In some embodiments, various parameters may include, but are not limited to, geolocation, industry type, time of year, current economic situation, or things of the like.

Still referring to FIG. 1, in an embodiment, at least a processor 108 may receive transport data associated with a step of entity process. For the purposes of this disclosure, “transport data” is information pertaining to a transport. Transport data may include, without limitation, origins, destinations, geographical data, estimated delivery times, estimated costs, and the like. Geographical data may include, without limitation, GPS coordinates, altitude, longitude, latitude, and the like. In some embodiments, geographical data may include relative location data. “Relative location data” as used in this disclosure is information pertaining to a particular geographical point. Relative location data may include, for instance and without limitation, distances between two or more geographical points, closest points of interest, and the like. A “transport”, for the purposes of this disclosure, is a movement of one or more objects between two or more locations. Thus, a transport, such as transport, includes transportation of cargo. For instance, and without limitation, a means of transport includes one or more processes of moving cargo, such as from one location (e.g., an origin) to another location (e.g., a destination) using a transport vehicle. Transport may include, without limitation, transport vehicles, transport components, and the like. “Transport vehicles” as used in this disclosure are devices configured to provide locomotive capabilities. Transport vehicles may include, without limitation, cars, trucks, motorcycles, boats, planes, drones, bicycles, any other mobile structure, and the like. “Transport components” as used in this disclosure are objects that are moved between two or more locations. Transport components may include cargo. Transport components may include, without limitation, construction materials, electronics, perishables, food, consumer goods, clothes, industrial equipment, parcels, freight shipments, and the like.

Still referring to FIG. 1, in some embodiments, transport data may include transport component data. “Transport component data” as used throughout this disclosure is information pertaining to objects of a transport. Transport component data may include, without limitation, dimensions such as height, width, length, volume, and the like. Transport component data may include, without limitation, values of components, costs associated with transporting components, and the like. For instance, and without limitation, transport component data of transport data may include a value of $510.27 for a package of apples in bulk. In some embodiments, transport component data may include one or more transport component statuses. A “transport component status” as used in this disclosure is a condition of a transport component. A transport component status may include, without limitation, hazardous material, frangible, damaged, and/or other conditions. In some embodiments, transport data may include one or more transport characteristics. A “transport characteristic”, as used in this disclosure, is an attribute relating to a transport. Transport characteristics may include, without limitation, expedited, overnight, freight, parcel, international, domestic, land, sea, air, and the like. In some embodiments, system 100 may use a transport characteristic classifier to classify transport to one or more transport characteristic categories. A transport characteristic classifier may be trained with training data correlating transport data to transport characteristic groupings, such as, without limitation, freight, expedited, hazardous, parcel, international, domestic, land, sea, air, overnight, and the like. Training data may be received from an external computing device, user input, and/or previous iterations of processing. A transport characteristic classifier may be configured to input transport data and categorize transport and/or transport components of transport to one or more characteristics groupings.

Still referring to FIG. 1, in an embodiment, entity process may include manufacturing data. As used in this disclosure, “manufacturing data” is information pertaining to manufacturing. Manufacturing data may include, without limitation, geographical data, estimated completion times, estimated costs, and the like. Geographical data may include, without limitation, GPS coordinates, number of orders, and the like. In some embodiments, geographical data may include relative location data. As used in this disclosure, “manufacturing”, is a production of a product. For instance, and without limitation, a manufacturing may include one or more processes of building a product such as forming a singular piece from multiple pieces using manufacturing methods. “Manufacturing components” as used in this disclosure are objects that are moved between two or more locations. Manufacturing components may include cargo. Manufacturing components may include, without limitation, construction materials, electronics, perishables, food, consumer goods, clothes, industrial equipment, parcels, freight shipments, and the like.

In further reference to FIG. 1, in an embodiment, user interface 120 may further include a dashboard 124 that displays a current status of module activation, performance metrics, and progress toward target function 140. For purposes of this disclosure, a “dashboard” is a visual interface that aggregates and displays key information, metrics, and data insights. The dashboard 124 may provide users with a real-time overview of critical system functions, enabling quick decision-making and monitoring of various performance indicators. In an embodiment, the dashboard 124 may be beyond serving as a simple display, for example, the dashboard 124 may actively monitor the operational status of different modules, indicating which parts of system 100 are currently active or inactive. The dashboard 124 may also provide detailed performance metrics, such as efficiency, throughput, or error rates, allowing users to gauge how well system 100 is functioning. Additionally, by showing progress toward a target function 140, the dashboard 124 may help track how close a user is to achieving predefined goals or benchmarks, thereby facilitating proactive management and timely adjustments if performance deviates from expected parameters.

In continued reference to FIG. 1, in an embodiment, system 100 includes a computing device 104. Computing device 104 includes a processor communicatively connected to memory 112 containing instructions 116 configuring at least a processor 108 to initiate methods or tasks as described herein. As used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Further referring to FIG. 1, computing device 104 may include any computing device as described in this disclosure, including without limitation a microcontroller, microprocessor, digital signal processor (DSP) and/or system on a chip (SoC) as described in this disclosure. Computing device 104 may include, be included in, and/or communicate with a mobile device such as a mobile telephone or smartphone. Computing device 104 may include a single computing device operating independently, or may include two or more computing device operating in concert, in parallel, sequentially or the like; two or more computing devices may be included together in a single computing device or in two or more computing devices. Computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device 104 may include but is not limited to, for example, a computing device or cluster of computing devices in a first location and a second computing device or cluster of computing devices in a second location. Computing device 104 may include one or more computing devices dedicated to data storage, security, distribution of traffic for load balancing, and the like. Computing device 104 may distribute one or more computing tasks as described below across a plurality of computing devices of computing device, which may operate in parallel, in series, redundantly, or in any other manner used for distribution of tasks or memory between computing devices. computing device 104 may be implemented, as a non-limiting example, using a “shared nothing” architecture.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Continuing to reference FIG. 1, in an embodiment, at least a processor 108 may be configured to display a current status of module activation, performance metrics, and progress toward target function 140 at a display device 128. Display device 128 may include a GUI, wherein GUI is updated based on one or more user inputs 132. A “display device” refers to an electronic device that visually presents information to the entity. In some cases, display device 128 may be configured to project or show visual content generated by computers, video devices, or other electronic mechanisms. In some cases, display device 128 may include a liquid crystal display (LCD), a cathode ray tube (CRT), a plasma display, a light emitting diode (LED) display, and any combinations thereof. In a non-limiting example, one or more display devices may vary in size, resolution, technology, and functionality. Display device 128 may be able to show any data elements and/or visual elements in various formats such as, textural, graphical, video among others, in either monochrome or color. Display device 128 may include, but is not limited to, a smartphone, tablet, laptop, monitor, tablet, and the like. Display device 128 may include a separate device that includes a transparent screen configured to display computer generated images and/or information. In some cases, display device 128 may be configured to present a GUI to a user, wherein a user may interact with the GUI. In some cases, a user may view a GUI through display. Additionally, or alternatively, processor 108 may be connected to display device 128.

In further reference to FIG. 1, in an embodiment, at least a processor 108 is configured to receive, at user interface 120, profile entity including at least an environment selection 136 and a target function 140. In some cases, receiving profile entity may include receiving a user input 132. In an embodiment, user input 132 can be entered through various means, such as a keyboard, mouse, touchscreen, voice command, or other interactive devices. In an embodiment, user input 132 may include environment selection 136. For purposes of this disclosure, an “environment selection” refers to a user-provided input that specifies the operational context or set of conditions under which the system will function. In other words, environment selection 136 may include the parameter by which the user defines the specific environment, such as market conditions, geographic region, industry-specific settings, or any other contextual criteria, that influences how the system generates its policies, activates modules progressively, and refines performance over time. In one embodiment, environment selection 136 may include various parameters that define the operational context. For instance, environment selection 136 may capture geographic or market contexts such as region, country settings, industry classifications, or market conditions including levels of competition or emerging market trends. Additionally, environment selection 136 may encompass operational conditions such as resource availability, infrastructure specifics (e.g., cloud-based versus on-premise), and any regulatory or compliance constraints that may influence system 100 behavior. User-defined variables, such as business goals, target outcomes, or preferences regarding risk, speed, and cost efficiency, may also be incorporated to further tailor the system's configuration.

In further reference to FIG. 1, in an embodiment, various methods may be employed to gather environment selection 136. One approach may include using questionnaires or surveys that prompt users with detailed questions, allowing for open-ended responses or multiple-choice selections to capture a comprehensive set of environmental factors. Alternatively, web-based forms may be utilized where users input data into designated text fields or select from predefined options, ensuring a structured and standardized data collection process. Drop-down menus can provide predefined lists for key categories such as regions or industries, thereby streamlining the selection process and reducing potential ambiguities. Furthermore, interactive quizzes or wizards may be implemented to guide users through a step-by-step process. In these interactive tools, subsequent questions may be dynamically adjusted based on previous responses, enabling a more accurate and refined environment selection 136. In some embodiments, dynamic dashboards may be employed to allow real-time adjustments, where users can interact with charts, sliders, or other graphical elements to directly manipulate environmental parameters. This immediate visual feedback may not only enhance user experience but also ensure that the data collected is relevant and comprehensive for subsequent policy 148 generation and progressive module activation.

Still referring to FIG. 1, in an embodiment, environment selection 136 and related parameters may be garnered from one or more in-person or virtual meetings with relevant stakeholders. Such meetings may provide a dynamic forum for discussing and identifying the operational contexts, business objectives, and other critical parameters that define the environment in which system 100 is to operate. During these sessions, stakeholders can communicate detailed insights and preferences regarding market conditions, geographic factors, regulatory constraints, resource availability, and other pertinent variables. The information obtained during these meetings may be recorded and subsequently transcribed, or it may be captured in real time through the use of speech-to-text or natural language processing techniques. The resulting data, which encompasses both qualitative insights and quantitative parameters, may then be integrated into system 100 as part of the environment selection 136 input. This integration can occur through manual entry by a system operator or through automated data processing tools that extract the relevant environmental variables from the meeting content. Once integrated, the environment selection 136 data may serve as a foundational element in the generation of the policy 148 and the progressive activation of the modular suite 156. System 100 may leverage this comprehensive set of environmental inputs to tailor its operational parameters and to drive the adaptive refinement model 168, ensuring that the generated policies and module activations are contextually aligned with the specific conditions and objectives defined during the meetings or input by a user at user interface 120.

In further reference to FIG. 1, for purposes of this disclosure, a “target function” refers to the desired operational goal or performance objective. In an embodiment, target function 140 may define what system 100 is ultimately intended to achieve, serving as a benchmark against which the effectiveness of the policy 148 and the progressive activation of modules is measured. Target function 140 may act as the central outcome parameter that drives the generation of the policy 148, ensuring that every subsequent decision, ranging from module activation to iterative refinements, aligns with the overall objective. More specifically, the target function 140 may be provided as part of the initial user input 132 at the user interface 120. This input, in combination with the environment selection 136, may form the basis for generating a customized policy 148 that outlines the steps required to attain the desired outcome. The target function 140 may encompass a wide array of performance metrics, such as efficiency levels, throughput targets, cost reductions, or other industry-specific operational benchmarks. These criteria may then be used by system 100 to monitor and evaluate ongoing performance through captured time-series data 164, enabling the adaptive refinement model 168 to make informed adjustments to the policy 148 and progression schedule.

In continued reference to FIG. 1, in an embodiment, target function 140 may be defined to achieve a specific level of operational efficiency. For example, a target function 140 could be set to reduce the time required to complete a particular business process by 20%. This efficiency improvement might be measured through metrics such as average processing time per transaction or the cycle time for order fulfillment. System 100 may continuously capture and analyze time-series data 164 to determine whether the policy 148 is driving the desired decrease in processing times. In another embodiment, target function 140 might focus on throughput targets. For instance, an organization might define its target function 140 as increasing the number of units produced or services rendered per hour by a given percentage. System 100 may monitor production rates, analyze the collected performance data, and adjust the policy 148 to optimize resource allocation and workflow efficiency to meet this throughput target. A further example of target function 140 could involve cost reduction objectives. A business may set target function 140 to lower operational expenses by streamlining processes, reducing waste, or optimizing energy consumption. Performance metrics such as cost per unit or overall expense reductions may serve as benchmarks. The adaptive refinement model 168 may then use these benchmarks, alongside time-series data 164, to refine policies that incrementally activate new modules aimed at further cost efficiencies. Additionally, target function 140 might be tailored to industry-specific benchmarks. In a healthcare setting, for instance, the target function 140 could aim to improve patient throughput in an emergency department while maintaining high-quality care standards. Metrics such as patient wait times, treatment times, and patient satisfaction scores would be critical in assessing whether the desired operational goals are met. System 100 may leverage these metrics to adjust policies and the progression schedule accordingly. These examples may illustrate how target function 140 serves as a central outcome parameter. Target function 140 may be provided as part of the initial user input 132 and, when combined with the environment selection 136, may form the basis for generating a customized policy 148. This policy 148, which governs everything from module activation to iterative refinements, may ensure that subsequent decisions are aligned with the overall operational goal, whether that goal pertains to efficiency, throughput, cost reduction, or other performance objectives.

With continued reference to FIG. 1, in an embodiment, user input 132 may further include additional parameters including user preferences, entity performance metrics, and environmental variables. In some cases, adaptive refinement model 168 may use the additional parameters to enhance accuracy of policy 148 generation and progressive module activation. Entity performance metrics may include historical data, key performance indicators, or real-time measurements that provide insight into the operational efficiency and effectiveness of a given entity. These metrics may allow system 100 to benchmark current performance against past results and industry standards, ensuring that the generated policy 148 is both realistic and achievable. Additionally, environmental variables such as prevailing market conditions, regulatory landscapes, and geographic influences may be captured to ensure that the policy 148 generation is contextually aware and can adapt to external factors that may impact performance. In some cases, the adaptive refinement model 168 may leverage these additional parameters to enhance the accuracy and robustness of both policy 148 generation and progressive module activation. By integrating user preferences, entity performance metrics, and environmental variables into its decision-making process, the adaptive refinement model 168 can more precisely adjust its outputs to align with the desired target function 140. This integration may facilitate a dynamic and iterative approach whereby the policy 148 is continuously refined, taking into account real-time changes and feedback across multiple dimensions. The result is a system that not only responds to the current operational context but also proactively adapts to future conditions, thereby optimizing overall performance and user satisfaction.

With continued reference to FIG. 1, in an embodiment, system 100 may incorporate a data management component 144 configured to store and organize various data inputs, including time-series data 164, user preferences, entity performance metrics, and environmental variables, in a structured and accessible manner. The collected data may be stored in one or more databases or data repositories wherein each data element is associated with metadata tags such as timestamps, identifiers for the corresponding module or operational context, and other pertinent attributes. This indexing may facilitate efficient retrieval, sorting, and filtering of data subsets, which may be essential for both real-time processing and subsequent analysis. Moreover, system 100 may employ advanced indexing methods, such as hierarchical or multi-dimensional indexing, to enhance query performance and support complex data analytics. The data management component 144 may also implement normalization and standardization techniques, ensuring that data originating from disparate sources, such as real-time web-based inputs, in-person meeting transcriptions, and manual user inputs 132, is consistently formatted and readily integrated into the adaptive refinement model 168. By organizing the data in this structured manner, system 100 not only streamlines the process of iterative policy 148 refinement but may also provide a robust framework for auditing historical performance and enabling predictive analysis for future policy 148 adjustments.

In further reference to FIG. 1, in an embodiment, at least a processor 108 is configured to generate a policy 148, comprising a set of steps, as a function of environment selection 136 and target function 140. For purposes of this disclosure, a “policy” is a systematic set of instructions or a decision-making framework that governs the operation of the system. For example, policy 148 may include a series of steps or actions that system 100 is programmed to execute in order to achieve the desired outcome as specified by the target function 140. The process of generating this policy 148 may involve the integration of the environment selection 136, which characterizes the specific operational context, and the target function 140, which outlines the ultimate performance objective. At least a processor 108 may be configured to generate the policy 148 based on the input provided by the user. In this context, at least a processor 108 may take the environmental parameters and the defined target function 140 as inputs and translate them into a structured sequence of steps that may include, for example, criteria for module activation, performance monitoring benchmarks, and adaptive refinement procedures. The resulting policy 148 may effectively act as a blueprint for the progressive activation of the modular suite 156, ensuring that each step or decision made by system 100 is aligned with the operational context and the desired outcome. Moreover, the policy 148 may be dynamic in nature and may be iteratively refined using real-time operational data 192a captured by system 100. As time-series data 164 is collected and processed by the adaptive refinement model 168, the policy 148 can be updated to reflect changes in environmental conditions, performance metrics, or other relevant factors. This adaptive approach may ensure that system 100 remains responsive to fluctuations in the operating environment and continuously optimizes its sequence of operations to better meet the target function 140.

With further reference to FIG. 1, in an embodiment, system 100 may incorporate a lookup table to facilitate rapid access to preconfigured policies or activation steps. The lookup table may contain entries that map various combinations of environment selections 136 and target functions 140 to specific policy 148 parameters. Each entry within the lookup table may represent a predetermined policy 148 that has been derived from historical performance data or expert system configurations, thereby serving as a reference for initializing or adjusting the modular suite's 156 operation. To further enhance this process, a classification model may be implemented to match the present user inputs 132, specifically, the environment selection 136 and target function 140, to one or more appropriate lookup tables. The classification model may be trained on a dataset comprising historical user inputs 132 and the corresponding optimal lookup table entries, enabling it to determine the most relevant policy 148 for a given set of inputs. Upon receiving the user input 132, the classification model may analyze the data and output a classification label that identifies the specific lookup table entry that best corresponds to the input parameters. System 100 may then utilize the mapping to retrieve and apply the associated policy 148, ensuring that the subsequent actions align with the user's desired operational context and performance goals. In some embodiments, feature learning may be employed to refine the classification process further. The classification model may include a feature learning module, such as a neural network with multiple layers, to automatically extract salient features from the user inputs 132. The feature learning module may process raw input data to derive a higher-level representation that captures underlying patterns or correlations inherent in the environment selection 136 and target function 140. By incorporating this refined feature set, the classification model may enhance its accuracy in matching the inputs to the appropriate lookup table entries. Consequently, the lookup table may be accessed with greater precision, and system 100 may be better able to generate or update the policy 148 that governs the progressive activation of the modular suite 156. Overall, the integration of a lookup table with a classification model, and, where applicable, feature learning, may enable a dynamic and adaptive mechanism for translating user inputs 132 into tailored policies. This approach may ensure that system 100 responds effectively to varying environmental conditions and operational goals, thereby optimizing performance and adaptability in real-time applications.

Still referring to FIG. 1, in an embodiment, the classification model may use a classifier. A “classifier,” as used in this disclosure is a machine-learning model, such as a mathematical model, neural net, or program generated by a machine learning algorithm known as a “classification algorithm,” as described in further detail below, that sort inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Computing device 104 and/or another device may generate a classifier using a classification algorithm, defined as a processes whereby computing device 104 derives a classifier from training data. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 1, computing device 104 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device 104 may then calculate a likelihood table by calculating probabilities of different data entries and classification labels. Computing device 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 1, computing device 104 may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristics may include selecting some number of highest-ranking associations and/or training data elements.

With continued reference to FIG. 1, generating k-nearest neighbors algorithm may generate a first vector output containing a data entry cluster, generating a second vector output containing an input data, and calculating the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 1, in an embodiment, the feature learning module may utilize one or more feature learning algorithms. A “feature learning algorithm,” as used herein, is a machine-learning algorithm that identifies associations between elements of data in a data set, which may include without limitation a training data set, where particular outputs and/or inputs are not specified. For instance, without limitation, a feature learning algorithm may detect co-occurrences of elements of data, as defined above, with each other. As a non-limiting example, feature learning algorithms may detect co-occurrences of elements, as defined above, with each other. Computing device 104 may perform a feature learning algorithm by dividing elements or sets of data into various sub-combinations of such data to create new elements of data and evaluate which elements of data tend to co-occur with which other elements. In an embodiment, first feature learning algorithm may perform clustering of data.

Continuing to refer to FIG. 1, a feature learning and/or clustering algorithm may be implemented, as a non-limiting example, using a k-means clustering algorithm. A “k-means clustering algorithm” as used in this disclosure, includes cluster analysis that partitions n observations or unclassified cluster data entries into k clusters in which each observation or unclassified cluster data entry belongs to the cluster with the nearest mean. “Cluster analysis” as used in this disclosure, includes grouping a set of observations or data entries in way that observations or data entries in the same group or cluster are more similar to each other than to those in other groups or clusters. Cluster analysis may be performed by various cluster models that include connectivity models such as hierarchical clustering, centroid models such as k-means, distribution models such as multivariate normal distribution, density models such as density-based spatial clustering of applications with nose (DBSCAN) and ordering points to identify the clustering structure (OPTICS), subspace models such as biclustering, group models, graph-based models such as a clique, signed graph models, neural models, and the like. Cluster analysis may include hard clustering whereby each observation or unclassified cluster data entry belongs to a cluster or not. Cluster analysis may include soft clustering or fuzzy clustering whereby each observation or unclassified cluster data entry belongs to each cluster to a certain degree such as for example a likelihood of belonging to a cluster; for instance, and without limitation, a fuzzy clustering algorithm may be used to identify clustering of elements of a first type or category with elements of a second type or category, and vice versa. Cluster analysis may include strict partitioning clustering whereby each observation or unclassified cluster data entry belongs to exactly one cluster. Cluster analysis may include strict partitioning clustering with outliers whereby observations or unclassified cluster data entries may belong to no cluster and may be considered outliers. Cluster analysis may include overlapping clustering whereby observations or unclassified cluster data entries may belong to more than one cluster. Cluster analysis may include hierarchical clustering whereby observations or unclassified cluster data entries that belong to a child cluster also belong to a parent cluster.

With continued reference to FIG. 1, computing device may generate a k-means clustering algorithm receiving unclassified data and outputs a definite number of classified data entry clusters wherein the data entry clusters each contain cluster data entries. K-means algorithm may select a specific number of groups or clusters to output, identified by a variable “k.” Generating a k-means clustering algorithm includes assigning inputs containing unclassified data to a “k-group” or “k-cluster” based on feature similarity. Centroids of k-groups or k-clusters may be utilized to generate classified data entry cluster. K-means clustering algorithm may select and/or be provided “k” variable by calculating k-means clustering algorithm for a range of k values and comparing results. K-means clustering algorithm may compare results across different values of k as the mean distance between cluster data entries and cluster centroid. K-means clustering algorithm may calculate mean distance to a centroid as a function of k value, and the location of where the rate of decrease starts to sharply shift, this may be utilized to select a k value. Centroids of k-groups or k-cluster include a collection of feature values which are utilized to classify data entry clusters containing cluster data entries. K-means clustering algorithm may act to identify clusters of closely related data, which may be provided with user cohort labels; this may, for instance, generate an initial set of user cohort labels from an initial set of data, and may also, upon subsequent iterations, identify new clusters to be provided new labels, to which additional data may be classified, or to which previously used data may be reclassified.

With continued reference to FIG. 1, generating a k-means clustering algorithm may include generating initial estimates for k centroids which may be randomly generated or randomly selected from unclassified data input. K centroids may be utilized to define one or more clusters. K-means clustering algorithm may assign unclassified data to one or more k-centroids based on the squared Euclidean distance by first performing a data assigned step of unclassified data. K-means clustering algorithm may assign unclassified data to its nearest centroid based on the collection of centroids ci of centroids in set C. Unclassified data may be assigned to a cluster based on [symbol] dist(ci, x)², where argmin includes argument of the minimum, ci includes a collection of centroids in a set C, and dist includes standard Euclidean distance. K-means clustering module may then recompute centroids by taking mean of all cluster data entries assigned to a centroid's cluster. This may be calculated based on ci=1/|Si|Σ>xi [symbol] Si^{xi}. K-means clustering algorithm may continue to repeat these calculations until a stopping criterion has been satisfied such as when cluster data entries do not change clusters, the sum of the distances have been minimized, and/or some maximum number of iterations has been reached.

Still referring to FIG. 1, k-means clustering algorithm may be configured to calculate a degree of similarity index value. A “degree of similarity index value” as used in this disclosure, includes a distance measurement indicating a measurement between each data entry cluster generated by k-means clustering algorithm and a selected element. Degree of similarity index value may indicate how close a particular combination of elements is to being classified by k-means algorithm to a particular cluster. K-means clustering algorithm may evaluate the distances of the combination of elements to the k-number of clusters output by k-means clustering algorithm. Short distances between an element of data and a cluster may indicate a higher degree of similarity between the element of data and a particular cluster. Longer distances between an element and a cluster may indicate a lower degree of similarity between elements to be compared and/or clustered and a particular cluster.

With continued reference to FIG. 1, k-means clustering algorithm selects a classified data entry cluster as a function of the degree of similarity index value. In an embodiment, k-means clustering algorithm may select a classified data entry cluster with the smallest degree of similarity index value indicating a high degree of similarity between an element and the data entry cluster. Alternatively, or additionally k-means clustering algorithm may select a plurality of clusters having low degree of similarity index values to elements to be compared and/or clustered thereto, indicative of greater degrees of similarity. Degree of similarity index values may be compared to a threshold number indicating a minimal degree of relatedness suitable for inclusion of a set of element data in a cluster, where degree of similarity indices a-n falling under the threshold number may be included as indicative of high degrees of relatedness. The above-described illustration of feature learning using k-means clustering is included for illustrative purposes only and should not be construed as limiting potential implementation of feature learning algorithms; persons skilled in the art, upon reviewing the entirety of this disclosure, will be aware of various additional or alternative feature learning approaches that may be used consistently with this disclosure.

In further reference to FIG. 1, in an embodiment, at least a processor 108 is configured to progressively activate one or more modules 152 of the modular suite 156 as a function of a predetermined progression schedule 160. For purposes of this disclosure, a “modular suite” refers to a collective set of modules that can be independently activated, deactivated, or reconfigured as required. Each individual module of modular suite 156 may represent a distinct operational component or function within the overall system. For example, an individual module of one or more modules 152 may implement a specific algorithm, control a particular process, or execute defined tasks necessary to achieve the target function 140. For purposes of this disclosure, a “predetermined progression schedule” defines the sequence and timing by which one or more modules 152 of the modular suite 156 are progressively activated. In an embodiment, predetermined progression schedule 160 may be based on criteria such as performance thresholds, time-based triggers, or predefined milestones, ensuring that modules are activated in a controlled and systematic manner rather than simultaneously. For example, initial modules might be activated to establish a baseline performance or gather critical operational data 192a, and subsequent modules may be engaged once specific performance metrics are met or after a designated period.

With continued reference to FIG. 1, in an embodiment, system 100 may be configured to progressively activate modules of the modular suite 156 in alignment with distinct program phases, such as the Signature, 10×, and Free Zone Frontier stages, thereby correlating conceptual programs with specific technical functionalities. For example, during an initial “Signature” phase, system 100 may activate a foundational module that provides essential productivity tools and strategies. This module may include functionalities such as an Impact Filter, Entrepreneurial Time System, and Experience Transformer, which collectively help an entrepreneur build a self-managing company by establishing baseline performance metrics, habits, and mindsets necessary for long-term growth. Subsequently, once system 100 detects that predefined performance thresholds, such as improvements in operational efficiency and personal productivity, have been met, and the user has engaged with the Signature module for a designated time period, the predetermined progression schedule 160 may trigger the activation of additional modules corresponding to the “10×” phase. In this phase, system 100 may introduce advanced tools designed to support exponential growth. These additional modules might incorporate functionalities aimed at enhancing strategic vision and operational scaling, such as a 10× Growth Mindset Analyzer and a 10× Vision Planner, which further refine performance by leveraging real-time data, comparative analytics, and dynamic policy 148 adjustments. Finally, upon satisfying further performance and time-based criteria 162, system 100 may progress to the “Free Zone Frontier” phase. In this embodiment, system 100 may activate a suite of advanced modules that emphasize collaborative value creation and industry transformation. These modules can include features for advanced benchmarking, competitive analysis, and networked collaboration tools that enable entrepreneurs to break free from conventional competitive constraints. The Free Zone modules may integrate external real-time data, such as industry-specific performance benchmarks and market trends, using web-crawlers 172 and data management components 144, thereby facilitating a robust, data-driven approach for sustained competitive differentiation.

In further reference to FIG. 1, in an embodiment, progressive activation of one or more modules 152 may enable system 100 to manage resources efficiently, adapt to changing operational contexts, and optimize overall performance by activating additional functionalities only when they are needed or when system 100 has reached certain performance criteria. Each module within the modular suite 156 may be designed to build upon the capabilities established by previous modules, thereby integrating new tools, algorithms, and data sources in a cumulative manner. As the predetermined progression schedule 160 unfolds, system 100 may leverage the outputs and performance data generated by earlier modules to inform the activation and configuration of subsequent modules. This may result in an iterative enhancement process, where each additional module contributes both standalone functionality and enriched context, enabling more refined and targeted operations. Furthermore, by ensuring that each module builds on the preceding ones, system 100 may create a scalable and adaptive architecture. New functionalities and tools may be integrated in a way that enhances the overall operational intelligence and responsiveness of system 100, while also ensuring that resource allocation remains aligned with current performance metrics and operational demands. This cumulative integration not only optimizes system's 100 immediate response to changing environments but may also establish a foundation for future enhancements. The modular design thus may support continuous improvement and strategic evolution, allowing system 100 to meet increasingly complex operational challenges while maintaining efficiency and effectiveness.

In continued reference to FIG. 1, in an embodiment, one or more modules 152 of modular suite 156 may include a first module 172a configured to determine a resource distribution. As used in the current disclosure, a “resource distribution” is a plan to distribute the resources of entity. For example, resource distribution may include a plan to determine how to distribute the current resources of an entity. In an embodiment, resource distribution may be generated with a goal of minimizing the current operational functions of a user and/or other member affiliated with the entity. This “sub” goal may align with target function 140. In an embodiment determining resource distribution may include identifying a plurality of resource data 180a as a function of entity profile 118. For purposes of this disclosure, “resource data” is an element of data associated with the resources of the entity. For example, resource data 180a may include employee logs, schedules, budgets, equipment usage records, supply inventories, facility availability, task assignments, time tracking reports, service capacity metrics, and/or the like. Resource data 180a may support informed decision-making around how resources are allocated, maintained, and adjusted. In a non-limiting example, resource data 180a may indicate that there are 5 employees plus the user who is available to the entity for 10 hours apiece.

With continued reference to FIG. 1, in an embodiment, resources may include anything an entity uses to complete tasks, functions, or projects associated with the entity. For example, resources may include monetary resources, time, equipment, personnel, services, products, goods, and the like. Resource data 180a may be represented as the total amount of resources available to the entity at a given time. In an embodiment, resource data 180a may be calculated by identifying the quantity of available personnel, equipment, and facilities that are available to the entity and the time for which those resources are available. In some embodiments, if a resource has been previously consumed or has plans to be consumed the resource may be considered unavailable. In a non-limiting example, resource data 180a may indicate that a company has 5 employees and 3 pieces of equipment available for 100 hours each over a two-week span. If an entity plans to have 3 employees use 3 pieces of equipment for 100 hours each during that span, resource data 180a may indicate that the available resources are 200 hours from two employees. Resource data 180a may additionally be represented as an aggregate of the time, money, personnel, and equipment that will be needed to complete a task or function. In a non-limiting example, resource data 180a may include the number of employees and equipment for one workday. Resource data 180a may additionally be represented as the cost of the resources. In continuance of the above example, resource data 180a may be represented in monetary terms by calculating the salary of the employees for one day along with the cost to use the equipment for a day. Resources may include inventory, monetary resources, number of employees, employee skill level, employee time, equipment, equipment time, and the like. Resource data 180a may also include a time cost. As used in the current disclosure, a “time cost” is the amount of time that it will take to complete a task associated with function data 180b along with the monetary value of the time. In some embodiments, one employee's time may hold a greater monetary value than another employee's time. The value of an employee's time may be determined by job title, seniority, credentials, experience, and the like. In a non-limiting example, a CEO who has 25 years of experience's time may be valued at $1000 per hour, as compared to a recent college graduate whose time may be valued at $100 per hour. At least a processor 108 may be configured to calculate resource data 180a as a function of the personnel data and function data 180b. In some embodiments, an element of resource data 180a may include outlier clusters representing areas of particular competence and/or efficiency associated with personnel. In a non-limiting example, the outlier clusters may be the same or substantially the same as the outlier clusters described in U.S. patent application Ser. No. 18/141,320, filed on Apr. 28, 2023, titled “METHOD AND AN APPARATUS FOR ROUTINE IMPROVEMENT FOR AN ENTITY,” which is incorporated by reference herein in its entirety.

With further reference to FIG. 1, in some cases, determining a resource distribution includes determining apportionment data 180c associated with plurality of function data 180b as a function of the plurality of resource data 180a. “Apportionment data,” as used in this disclosure, is data associated with the quantity of resources needed to complete a task represented by function data 180b. In an embodiment, apportionment data 180c may include the time cost associated with a task. In a non-limiting example, apportionment data 180c may indicate that an employee should spend three hours on a task, indicating that the task was completed efficiently. An “estimated completion time,” as used herein, is an estimation of how long a task associated with function data 180b should take to be completed. In some embodiments, estimated completion time may be stored in a database, database. In some embodiments, at least a processor 108 may estimate the completion time for a function by querying a database, where the database includes completion times for other users and/or personnel. In an embodiment, at least a processor 108 may estimate the completion time for a function based on a plurality of queried completion times. In a non-limiting example, at least a processor 108 may query a database for the completion time for a task, where the task may have different completion times for each person in the database. In this non-limiting example, at least a processor 108 may be configured to generate an estimated completion time by averaging the different completion times received. It will be apparent to one of ordinary skill, upon reading this disclosure, that many methodologies can be used to ascertain an estimated completion time for a function. In an embodiment, apportionment data 180c may be represented by the intersection of two fuzzy sets. For instance, and without limitation, the fuzzy set may include a center and/or centroid at a most likely and/or desirable value, a range weighted by the skill and experience of the employee. Weighting may be tuned according to one or more machine-learning processes. In an embodiment, weighting may be represented by a membership function curve, for which higher values may represent a greater degree of membership in a fuzzy set, while lower values represent a lower degree of membership therein.

With continued reference to FIG. 1, in an embodiment, at least a processor 108 may determine apportionment data 180c using a lookup table. A “lookup table,” for the purposes of this disclosure, is a data structure, such as without limitation an array of data, that maps input values to output values. A lookup table may be used to replace a runtime computation with an indexing operation or the like, such as an array indexing operation. A look-up table may be configured to pre-calculate and store data in static program storage, calculated as part of a program's initialization phase or even stored in hardware in application-specific platforms. Data within the lookup table may include previous examples of apportionment data 180c compared to function data 180b. Data within the lookup table may be received from a database. In an embodiment, lookup tables may also be used to identify apportionment data 180c by matching an input value to an output value by matching the input against a list of valid, or invalid, items in an array. In a non-limiting example, function data 180b may indicate that an entity has to accomplish Task 1. Stored apportionment data 180c may indicate that the completion time for Task 1 has historically been between 45 minutes and 1 hour when completed by an experienced employee whereas it takes nearly 2 hours when completed by a new employee. A lookup table may look up the user's function data 180b and personnel data as inputs and output apportionment data 180c indicating that the employee should complete the task in 1 hour and 20 minutes. In an embodiment, at least a processor 108 may be configured to “lookup” or input one or more of function data 180b, entity data, personnel data, exemplary apportionment data 180c, and the like at the lookup table. Whereas the output of the lookup table may include apportionment data 180c. Data from the lookup table may be compared to examples of apportionment data 180c, for instance, and without limitation using string comparisons, numerical comparisons such as subtraction operations, or the like; discrepancies may indicate data faults. Alternatively, and/or additionally, a query representing elements of apportionment data 180c may be submitted to the lookup table and/or a database, and an associated data fault identifier stored in a data record within the lookup table and/or database may be retrieved using the query.

With continued reference to FIG. 1, in an embodiment, determining a resource distribution may include generating optimized apportionment data 180d as a function of the apportionment data 180c and plurality of resource data 180a. As used in the current disclosure, “optimized apportionment data 180d” is the ideal allocation of all operational functions. An ideal allocation may be considered the allocation of all operational functions to employees other than the user. As used in the current disclosure, “operational functions” are the activities that an entity and its affiliated members engage in on a regular basis to further the purpose of the entity. Operational functions may include lower-level non-managerial tasks. Examples of operational functions may include providing services, producing goods, delivering goods, maintaining equipment, maintaining facilities, janitorial services, non-skilled labor, skilled labor, physical labor, making deliveries, and the like. The determination of optimized apportionment data 180d may include a comparison of the apportionment data 180c and the resource data 180a. In an embodiment, apportionment data 180c may be compared to resource data 180a to determine if function data 180b assigned to the user is an assignable function. An “assignable function,” as used herein, is a function that can be performed by another individual other than the user. In some embodiments, determining at least an assignable function may include identifying a time deficit for each function from plurality of function data 180b, wherein identifying time deficit includes comparing estimated completion time to the average employee's completion time for each function associated with the function data 180b. A “time deficit,” as used herein, is the additional time an employee takes to complete a task as compared to the estimated completion time of that task. In an embodiment, time deficit may be identified by subtracting estimated completion time from the employee's completion time or the user's completion time. It will be apparent to someone of ordinary skill in the art, upon reading this disclosure, the many methodologies may be used for identifying time deficits.

In continued reference to FIG. 1, in an embodiment, determining optimized apportionment data 180d may include ranking a ranking of the function data 180b as a function of time deficit. In some embodiments, at least a processor 108 may use a scoring function for ranking function data 180b. For example, without limitations, at least a processor 108 may assign scores based on time deficit, where the higher the time deficit the lower the score. In some embodiments, at least a processor 108 may determine assignable functions for all tasks with a time deficit above a set threshold. In a non-limiting example, a set threshold may be a set of minutes, such as a threshold of minutes. In a further nonlimiting example, at least a processor 108 may determine all tasks with a time deficit of 20 minutes or more as assignable functions. In an embodiment, at least a processor 108 may determine only the function with the highest time deficit as at least an assignable function.

With further reference to FIG. 1, in an embodiment, determining optimized apportionment data 180d as a function of apportionment data 180c and plurality of resource data 180a may include identifying at least one constraint associated with apportionment data 180c using a constraint machine-learning model 182a that has been trained on a dataset including apportionment data 180c correlated to historical constraints. “Constraint,” as used herein refers to a barrier, limitation, or consideration pertaining to resource utilization or planning. In an embodiment, at least a constraint may alter the time and/or resources available to perform a task or it may alter the concurrent and/or sequential ordering of tasks in a function order, and/or may alter the feasibility of combining a plurality of tasks. In some cases, constraints may be identified by an optimization process such as the optimization of apportionment data 180c. Constraints may be identified using previous iterations of constraints and optimized apportionment data 180d. A constraint may, for instance, and without limitation, only appear during a particular optimized listing of a task represented by function data 180b, wherein a second listing of the same elements in a different ordering may not show the same constraint. In non-limiting illustrative examples, a constraint may include a resource constraint, wherein dedicating an individual to a series of tasks for preparing a meal would then place a constraint on preparing a second meal with said individual or performing a second combination of tasks; likewise a constraint may include a time constraint wherein the maximal time allotted for selecting tasks for an individual or set of individuals working in tandem in preparing a meal may be dictated by when a customer places an order, whether a customer is dine-in or take-out, delivery method for the meal, and/or type of meal and ingredients used. Constraints may additionally refer to customer/user preferences. Such information, in some cases, may be stored and/or retrieved by at least a processor 108 from a database. In an embodiment, a constraint may include qualifications and/or certifications related to an employee of the user. For example, a constraint on the use of a forklift may include: 1. An employee available to use the forklift and 2. That employee is certified to use the forklift.

Continuing in reference to FIG. 1, at least a processor 108 may select or generate optimized apportionment data 180d that satisfies the plurality of constraints using an objective function. An “objective function,” as used in this disclosure, is a mathematical function with a solution set including a plurality of data elements to be compared, including resource data 180a and apportionment data 180c. The objective function may generate an output scoring optimized apportionment data 180d combinations according to at least a with the goal to minimize institutional tasks performed by the user. In an embodiment, at least a processor 108 may compute a score, metric, ranking, or the like, associated with each resource data 180a and apportionment data 180c and select optimized apportionment data 180d to minimize and/or maximize the score, depending on whether an optimal result is represented, respectively, by a minimal and/or maximal score; an objective function may be used by at least a processor 108 to score each possible pairing. An objective function may be based on one or more objectives or constraints. In an embodiment, at least a processor 108 may pair a combination of resources allotted to the availability of the tasks or sets of tasks, that optimize the objective function. In various embodiments, a score of optimized apportionment data 180d may be based on a combination of one or more factors, including a plurality of constraints and/or the number of operational functions assigned to the user. Each factor may be assigned a score based on predetermined variables.

In continued reference to FIG. 1, in an embodiment, optimization of an objective function with a solution set including the optimized apportionment data 180d may include performing a greedy algorithm process, where optimization is performed by minimizing and/or maximizing the output of an objective function through a selection of inputs such as task combinations. A “greedy algorithm” is defined as an algorithm that selects locally optimal choices, which may or may not generate a globally optimal solution. For instance, at least a processor 108 may select objectives so that scores associated therewith are the best score for each goal. For instance, in the non-limiting illustrative example, optimization may determine the combination of routes for a courier such that each delivery pairing includes the highest score possible, and thus the most optimal delivery.

Still referring to FIG. 1, the objective function may alternatively be formulated as a linear objective function, which at least a processor 108 may optimize using a linear program such as without limitation a mixed-integer program. A “linear program,” as used in this disclosure, is a program that optimizes a linear objective function, given at least a constraint; a linear program may be referred to without limitation as a “linear optimization” process and/or algorithm. For instance, in non-limiting illustrative examples, a given constraint might be a personnel constraint, and a linear program may use a linear objective function to calculate a minimized time per task without sacrificing the quality of the tasks. In various embodiments, system 100 may determine a set of instructions towards achieving a user's optimal resource distribution that maximizes a total score subject to a constraint that there are other competing objectives. A mathematical solver may be implemented to solve for the set of instructions that maximizes scores; a mathematical solver may be implemented on at least a processor 108 and/or another device in system 100, and/or may be implemented on a third-party solver.

With continued reference to FIG. 1, generating an objective function of optimized apportionment data 180d may include minimizing a loss function, where a “loss function” is an expression of an output of which a ranking process minimizes to generate an optimal result. As a non-limiting example, at least a processor 108 may assign variables relating to a set of parameters, which may correspond to score components as described above, calculate an output of mathematical expression using the variables, and select an objective that produces an output having the lowest size, according to a given definition of “size,” of the set of outputs representing each of plurality of candidate ingredient combinations; size may, for instance, included absolute value, numerical size, or the like. Selection of different loss functions may result in the identification of different potential pairings as generating minimal outputs.

With continued reference to FIG. 1, in an embodiment at least a processor 108 may identify at least a constraint using a constraint machine-learning model 182a. As used in the current disclosure, a “constraint machine-learning model” is a machine-learning model that sorts inputs into categories or bins of data, outputting the categories or bins of data and/or labels associated therewith. Constraint machine-learning model 182a may be consistent with a classifier or machine-learning model described throughout this disclosure. Inputs to the constraint machine-learning model 182a may include entity profile 118, entity data, function data 180b, resource data 180a, apportionment data 180c, examples of optimized apportionment data 180d, operational functions, function rank, assignable function, historical constraints, and the like. Outputs to the constraint machine-learning model 182a may include an identification of a constraint. Constraint training data may include a plurality of data entries containing a plurality of inputs that are correlated to a plurality of outputs for training at least a processor 108 by a machine-learning process to correlate apportionment data 180c to historical constraints. In an embodiment, historical constraints may include constraints that have been encountered by previous iterations of the machine learning model. Constraint training data may, in some cases, be received from a database. Constraint training data may contain information including, but not limited to entity profile 118, entity data, function data 180b, resource data 180a, apportionment data 180c, examples of optimized apportionment data 180d, operational functions, function rank, assignable function, historical constraints, and the like. Constraint training data may correlate apportionment data 180c to historical constraints. Classification may be performed using, without limitation, fuzzy inference sets, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 1, processor 108 may be configured to predict a breakaway point as a function of the optimized apportionment data 180d. As used in current disclosure, a “breakaway point” is the point in time wherein the user is relieved of their operational functions to focus on other facets of the business. The user may be described as an upper-level employee including executives, owners, significant equity holders, management, and the like. In some embodiments, the breakaway point may additionally be described as the point that the user no longer needs to be involved in the business. The breakaway point may additionally include the point in time that the business is self-sustaining requiring minimal interactions from the user. A breakaway point may also include the time period wherein the user's time cost is too high to perform operational functions. In an embodiment, a breakaway point may be when the user's time is better suited performing managerial functions vs operational functions. In a non-limiting example, entity data may indicate that the entity has doubled the number of services they provide over the last year, wherein the user has also been providing services. In an embodiment, at least a processor 108 may identify that the breakaway point is when the growth of the entity increases 150 percent from its current state. In an embodiment at least a processor 108 may use the determination of the optimized apportionment data 180d to predict the breakaway point. The optimized apportionment data 180d may provide a goal or a target for the entity to accomplish, which may align with target function 140, whereas the breakaway point is a prediction of when entity will reach that goal or target. In a non-limiting example, the breakaway point may be the same or substantially the same as the breakaway point described in U.S. patent application Ser. No. 18/142,389, filed on May 2, 2023, titled “APPARATUS AND A METHOD FOR THE IDENTIFICATION OF A BREAKAWAY POINT,” which is incorporated by reference herein in its entirety.

With continued reference to FIG. 1, at least a processor 108 may predict a breakaway point using a breakaway machine-learning model 182b. As used in the current disclosure, a “breakaway machine-learning model” is a machine-learning model that sorts inputs into categories or bins of data, outputting the categories or bins of data and/or labels associated therewith. Breakaway machine-learning model 182b may be consistent with classifiers or machine-learning models as described throughout this disclosure. Inputs to the breakaway machine-learning model 182b may include entity profile 118, entity data, function data 180b, resource data 180a, apportionment data 180c, examples of optimized apportionment data 180d, operational functions, function rank, assignable function, and the like. Outputs to the breakaway machine-learning model 182b may include a prediction of the breakaway point. Breakaway training data may include a plurality of data entries containing a plurality of inputs that are correlated to a plurality of outputs for training at least a processor 108 by a machine-learning process to correlate optimized apportionment data 180d to exemplary breakaway points. Breakaway training data may be received from a database. In an embodiment, breakaway training data may contain information about entity profile 118, entity data, function data 180b, resource data 180a, apportionment data 180c, examples of optimized apportionment data 180d, operational functions, function rank, assignable function, and the like. Breakaway training data may correlate optimized apportionment data 180d to examples of breakaway points. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With further reference to FIG. 1, in some embodiments, system 100 may determine a resource distribution as a function of a predicted breakaway point. At least a processor 108 may use a distribution machine-learning model 182c trained on historical data comprising optimized apportionment data 180d and corresponding breakaway points, each correlated to examples of resource distributions. The distribution machine-learning model 182c may output a resource distribution aligned with achieving a desired breakaway point, enabling dynamic reallocation of resources to accelerate or sustain such a breakaway. In an embodiment, this model may be used in conjunction with or downstream of the breakaway machine-learning model 182b described herein, wherein the predicted breakaway point acts as an input to refine the resource distribution.

In further reference to FIG. 1, in an embodiment, first module 172a may be further configured to determine at least one future process output 184a as a function of entity profile 118. As used in this disclosure, “future process output” is a desired result resulting from efforts by a member affiliated with an entity. For example, future process output 184a may include hosting a networking event, creating a new opportunity, signing a new client, and the like. In an embodiment, entity profile 118, in some cases optimized apportionment data 180d, may indicate that it may be beneficial for user to increase user visibility within selected environment.

Alternatively, or additionally, a fuzzy inferencing system for identification of at least one future process output 184a may be employed, where any or all future process outputs 184a may be represented as values and/or fuzzy sets for linguistic variables measuring the same. An inferencing system may use one or more fuzzy inferencing rules, as described in further detail below, to output one or more linguistic variable values and/or defuzzified values indicating the at least one future process output 184a. Further, Additionally, or alternatively, at least a processor 108 may be configured to receive a user input comprising at least one future process output 184a. User input may be consistent with any user input described herein.

With further reference to FIG. 1, in an embodiment, determining resource distribution may further include classifying entity profile 118 into one or more objective groups using an objective group classifier 184b. For example, at least a processor 108 may be configured to classify the at least one future process output 184a into objective groups such as personal objective, pecuniary objective, clustered group objective, and the like using the objective group classifier 184b. As used in this disclosure, “personal objective” is a desired result directed towards personal advancement of an individual user. “Pecuniary objective,” as used in this disclosure is a desired result relating fiscal advancement. Further, as used in this disclosure, “clustered group objective” is a desired result directed towards advancement of a clustered group. One skilled in art will recognize various other types of objective groups that may exist. Objective group classifier 184b may classify distinct routines to one or more types and/or categories of future process outputs 184a, which may include any type of future process output 184a category, sub-categories and/or more specific categories, or the like. For instance, objective group classifier 184b may receive future process output 184a data and classify the future process output 184a data according to type of future process output 184a such as personal objective, pecuniary objective, clustered group objective, or the like. Objective group classifier 184b may be trained using training data correlating future process output 184a data to a type of future process output 184a.

In further reference to FIG. 1, in an embodiment, system 100 may further align the predicted future process output 184a with user experience data 186b. For example, at least a processor 108 may analyze user experience data 186b, such as prior interactions, emotional history, and contextual background, to identify patterns or conditions under which a future process output 184a may be more or less effective. In some cases, future process outputs 184a may be ranked not only by benefit to the user but also by compatibility with the user's prior experiences and psychological or emotional readiness. For instance, if user experience data 186b includes repeated anxiety associated with public speaking, a predicted future process output 184a such as “host a networking event” may be deprioritized in favor of less emotionally taxing options. Alternatively, positive learning datum 186c extracted from user experience data 186b may increase the likelihood of selecting growth-oriented outputs that build upon prior resilience or success. In this way, the future process output 184a alignment model may incorporate both historical operational performance and personal context into its prioritization.

With continued reference to FIG. 1, determining resource distribution may further include predicting at least one future process output 184a using a future process output alignment machine-learning model 184c trained on historical entity profiles 118 and process outputs. In some cases, this determination may predict or output at least one future process output 184a with the highest priority based on minimization of resource consumption. In a non-limiting example, future process output alignment machine-learning model 184c may predict at least one future process output 184a that needs urgent attention. In such an example, other parameters may include non-optimal values that may allow for the future process output 184a to be addressed immediately. In such an example, the other parameters may be optimized second to the minimization of resource consumption. In some embodiments, one or more parameters may be weighted. The weight of the parameters may include an emphasis on certain parameters, such as, but not limited to, resources consumption and/or time constraints. In other embodiments, other parameters may be weighted which may allow said parameters to more heavily influence the optimization problem and the recommended remediation action. System 100 may align these parameters with optimized apportionment data 180d and generally with target function 140. In some cases, this alignment may be accomplished through a ranking process.

With further reference to FIG. 1, in an embodiment, at least a processor 108 may be configured to generate a ranked list of the at least one future process output 184a. For example, at least a processor 108 may generate an ordered list ranking each of the at least one future process output 184a in order based on a benefit to user. Such a list may indicate a first future process output 184a having the most relevance and/or effect on the user than a second future process output 184a, and the like. In an exemplary embodiment, at least a processor 108 may generate an ordered list ranking signing a new client, creating a new opportunity, and hosting a networking event in order. Such a list may indicate signing a new client having the most relevance and/or effect on user, creating a new opportunity having less relevance and/or effect than signing a new client but more relevance and/or effect than hosting a networking event. In some cases, this ranked list may be cross-referenced with optimized apportionment data 180d.

With continued reference to FIG. 1, the ranked list of at least one future process output 184a may be determined, as a non-limiting example, using a machine learning model. In an embodiment, the machine learning model may receive training data correlating a plurality of future process output 184a data to an effect of the future process output 184a data on the input data. In a further embodiment, input data may be classified into categories or cohorts of input data, for which relative importance of future process outputs 184a may be stored and/or determined using further machine learning methods, which can be used to determine the ranked list of at least one future process output 184a. For example, input data may be associated and/or classified into a category for users with similar input data. In a further exemplary embodiment, the user may be associated and/or classified with other users in the same field of operation, for example entrepreneur consulting companies, and the like. The database may also store data about the relative importance of each of future process outputs 184a for each of these categories and/or fields of operation. Additionally, or alternatively, a machine learning model may be used to determine the relative importance of each future process outputs 184a for each of these categories and/or fields of operation.

In further reference to FIG. 1, in an embodiment, determining resource distribution may further include adjusting the apportionment data 180c as a function of at least one future process output 184a and one or more objective groups. In such embodiments, system 100 may consider the classified objective group, such as a personal objective, pecuniary objective, or clustered group objective, in combination with the predicted or user-identified future process output 184a to influence resource allocation. In an embodiment, at least a processor 108 may adjust apportionment data 180c by incorporating the future process output 184a into a distribution machine-learning model 182c trained to predict optimal allocations under varying objective group constraints. For example, if the future process output 184a corresponds to signing a new client, a pecuniary objective, system 100 may prioritize reallocation of high-value personnel or extend resource availability to ensure preparatory tasks are fulfilled within the desired timeframe. Adjustments may be made by recalculating estimated completion times, assigning or reassigning operational functions, or reweighting time cost values to reflect alignment with the ranked future process output 184a. These modifications may be executed through a feedback loop wherein the adjusted apportionment data 180c is validated against existing resource constraints and re-optimized using the objective function described above. In this way, system 100 ensures that resource distribution is continuously refined to support goal-oriented outcomes while balancing current operational demands and entity profile 118 evolution.

With continued reference to FIG. 1, in an embodiment, first module 172a may be further configured to implement a post-action function 186a. “Post-action function” for the purposes of this disclosure is data including a set of instructions for a user after completion of an action or event. In some embodiments, post-action function 186a may include recommendations, feedback, or personalized instructions for the user based on learning datum 186c and growth data. In some embodiments, post-action function 186a may be configured to promote continuous improvement and advancement (e.g., enhance effectiveness, efficiency, skills, and the like) in user's experience in performing one or more actions. Post-action function 186a may include instructions on how to handle or resolve an activity or event. Post-action function 186a may further include instructions on how to prevent activities or events described above. Post-action function 186a may further include instructions on how to navigate activities or events in the future. In some cases, post-action function 186a may further include instructions on how to navigate future events that may occur as a result of the action or event in user experience data 186b. Post-action function 186a may further include instructions on how to increase a user's growth score. Post-action function 186a may further include projected growth data wherein projected growth data is speculated growth data that may be achieved in the future based on implementation of post-action function 186a. In some cases, at least one post-action function 186a may contain a plurality of individual action plans. As described in this disclosure an “individual action plan” is a set of instructions for a user with reference to one particular category, such as for example, one particular category within growth data and/or learning datum 186c, wherein post action plan may contain a plurality of individual action plans. A plurality of action plans may contain multiple routes on how a post-action function 186a may be implemented. For example, an individual action plan may include instructions on taking a course, whereas a second individual action plan may include instructions on taking an assessment. A user may be given the opportunity to choose one of the individual action plans, such as whichever individual action plan may be best suited for them. Additionally, or alternatively, each individual action plan may contain a predictive growth score, wherein the predictive score may predict a user's growth based on the implementation of the individual post-action function 186a. For example, a first individual post-action function 186a may contain a predictive growth score of 70 out of 100 whereas a second individual post-action function 186a may contain a predictive growth score of 85 out of a 100. A user may have a choice of choosing between the individual post-action function 186a. A user may choose an easier individual post-action function 186a that may suit their lifestyle even if the individual post-action function 186a contains a lower predictive growth score. In some cases, post-action function 186a may include a plurality of steps, wherein each step may signify a different stage in post-action function 186a. A user may follow the steps sequentially or out of order. In some cases, the plurality of steps must be followed in a sequential order. In some cases, post-action function 186a may further include a checklist wherein a user may check off each individual step that was completed. Additionally, or alternatively each step of the plurality of steps may contain an individual predictive growth score wherein the individual predictive growth score is a predictive score that determines a user's growth after each step. Growth score may be determined based on a predetermined score wherein completion or mastery of each step may indicate a rise in growth score. For example, knowledge or implementation of 5 out of 10 steps in post-action function 186a may give a user a growth score of 50/100. In some cases, each step or instructions may be given a different weighted amount based on its complexity. In some cases, each step or set of instructions may contain sub score out of 10 wherein mastery of the step may indicate a sub score of 10 and little knowledge or partial completion of the step may indicate a score of 3 or less. Predictive growth score may be calculated based on the plurality of individual predictive growth scores that have been calculated. In some cases, predictive growth score may be calculated based on previous iteration in which a similar user underwent a similar action or activity. Predictive growth score may be a predetermined growth score that has been calculated based on previous iterations.

In further reference to FIG. 1, in an embodiment, at least a processor may be configured to receive user experience data 186b associated with an entity. “User experience data,” for the purposes of this disclosure, is defined as any data relating to actions or events that are associated with a user. This may include, but is not limited to, a previous interaction a user had with another individual, an embarrassing event, a challenging event and the like. User experience data 186b may include data relating to an embarrassing event (e.g., slipping in a crowded area, slurring words during a presentation, forgetting to tie shoes, an uncomfortable conversation with another individual, a wardrobe mishap, and the like. User experience data 186b may further include data relating to a challenging event (e.g., loss of a loved one, raising a child, arguing with a spouse, experiencing abuse, losing a job, getting sued losing a business, divorce, and the like). User experience data 186b may further include data relating to the previous health of a user (e.g. weight gain, preventable health issues caused by an unhealthy lifestyle, a recently given diagnosis, a series of treatments the user has undergone, and the like). User experience data 186b may further include data relating to the interactions of a user (e.g. previously spoken conversations, issues with maintaining a proper conversation, issues with verbalizing a person's needs properly, issues relating to difficult conversations that took place, social anxiety and the like). User experience data 186b may further include a user's experience in relation to a user's fears (an upcoming event of a user wherein the user has a fear of speaking, an upcoming flight wherein a user has a fear of flying, an upcoming ski trip, wherein a user has a fear of skiing, and the like). User experience data 186b may further include data relating to a user's finances (e.g., spending history, gambling addictions, current financial situation, previous financial situations, and the like). User experience data 186b may further include physiological data (e.g. previous heart rates, oxygen levels, vitamin levels and the like). User experience data 186b may further include current or previous mental health of a user (e.g. depression, loneliness, sadness, happiness, feeling of lethargy, and the like). User experience data 186b may further include any significant life event with respect to a user. This may include life events that are not significant to an ordinary person but may be important to a particular user. User experience data 186b may further include any action or even in which a user may seek to learn or grow from. User experience data 186b may further include a “contextual background” of the event. Contextual background for the purposes of this disclosure is the acts or circumstances surrounding the action or event. This may include any data describing the circumstances of the event, such as the age of the user, the user's history with regards to a specific action or event, and the like.

With continued reference to FIG. 1, in an embodiment, user experience data 186b may include data in the form of audio, text, images, audio-visual data, and the like. In some cases, user experience data 186b may include a user's search history on from computing device 104, internet browser or website. In some cases, user experience data 186b may include financial documents, such as previous spending history, credit card transactions and the like. In some cases, user experience data 186b may include screenshots of conversations, actions or activities that were taken on a computing device. In some cases, user experience data 186b may include data captured from virtual environments. Virtual environment may include a plurality of devices connected through networks. In a non-limiting example, system 100 may be configured to receive user experience data 186b from the internet. Such user experience data 186b may include data from social media posts, feeds, browsing histories, and the like thereof. System 100 may utilize a web crawler to collect user experience data 186b in the virtual environment. Further, in some cases, system 100 may be configured to extract an action pattern, wherein the action pattern refers to a set of behaviors or actions taken by a user when interacting with the system 100.

With continued reference to FIG. 1, receiving user experience data 186b may include processing user experience data 186b. “Processing” for the purposes of this disclosure refers to the conversion, maintenance, or modification of data such that the data may be properly used by a computing device. For example, processing user experience data 186b may include compression by inter-frame coding as described in this disclosure. Processing user experience data 186b may further include converting user experience data 186b into text-based data. Computing device 104 may use “speech to text” or “Automatic speech recognition” in order to convert audio data inputted by a user into text data that may be used later on by computing device. “Automatic speech recognition (ASR)” also known as “speech recognition” or “speech to text” is a computer algorithm that may receive an input of audio data, wherein the audio data may include any recognizable sounds and convert those sounds into text based data. For example, a computing device 104 may output text data indicating that a car horn was heard in the audio-visual data. In another non limiting example, a computing device 104 may output speech related to a conversation that was recorded within the audio-visual data. A computing device, such as the one mentioned herein may receive audio or audio-visual data, break down the audio data into a plurality of phonemes, determine a sequence of the phonemes, compare the sequence to a plurality of sequence, and output a text based on the comparison of the plurality of sequences. ASR algorithms may use a plurality of algorithms to convert speech to text. This may include, but is not limited to hidden Markov models, dynamic time warping based speech recognition, neural networks, machine-learning algorithms and other algorithms that may convert text to speech. In some cases, receiving user experience data 186b may include transmitting user experience data 186b to an ASR device, wherein the ASR device is a device configured to convert audio data to speech. In some cases, the ASR device is communicatively connected to computing device 104. In some cases, the ASR device is wired or wirelessly connected to computing device 104. In some cases, computing device 104 includes ASR device. In some cases, ASR device may be connected to a network, wherein computing device 104 may transmit user experience data 186b to the network for processing. In some cases, ASR device is a preprogrammed device capable of speech to text recognition. In some cases, computing device 104 may implement already existing speech to text software or algorithms. Additionally, or alternatively, receiving user experience data 186b may include receiving text data from an ASR device.

With continued reference to FIG. 1, receiving user experience data 186b may further include processing user experience data 186b using an image classifier. An “image classifier,” as used in this disclosure is a machine-learning model, such as a mathematical model, neural net, or program generated by a machine-learning algorithm known as a “classification algorithm,” as described in further detail below, that sorts inputs of image information into categories or bins of data, outputting the categories or bins of data and/or labels associated therewith. Image classifier may be configured to output at least a datum that labels or otherwise identifies a set of images that are clustered together, found to be close under a distance metric as described below, or the like. Computing device 104 and/or another device may generate image classifier using a classification algorithm, defined as a process whereby computing device 104 derives a classifier from training data. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. In some cases, processor 108 may use an image classifier to identify a key image in user experience data 186b. As used herein, a “key image” is an element of visual data used to identify and/or match elements to each other. An image classifier may be trained with binarized visual data that has already been classified to determine key images in user experience data 186b. “Binarized visual data” for the purposes of this disclosure is visual data that is described in binary format. For example, binarized visual data of a photo may be comprised of ones and zeroes wherein the specific sequence of ones and zeros may be used to represent the photo. Binarized visual data may be used for image recognition wherein a specific sequence of ones and zeroes may indicate a product present in the image. An image classifier may be consistent with any classifier as discussed herein. An image classifier may receive an input of user experience and output a key image of user experience data 186b. An identified key image may be used to locate a data entry relating to the image data in user experience data 186b, such as an image depicting a significant event. In an embodiment, image classifier may be used to compare visual data in user experience data 186b with visual data in another data set, such as previously inserted user experience data 186b. In the instance of a video, at least a processor 108 may be used to identify a similarity between videos by comparing them. In an embodiment, at least a processor 108 may be configured to identify a series of frames of video. The series of frames may include a group of pictures having some degree of internal similarity, such as a group of pictures having similar components, scenery, location and the like depicted within them or similar color profiles. In some embodiments, comparing a series of frames may include video compression by inter-frame coding. The “inter” part of the term refers to the use of inter frame prediction. This kind of prediction tries to take advantage from temporal redundancy between neighboring frames enabling higher compression rates. Video data compression is the process of encoding information using fewer bits than the original representation. Any compression may be either lossy or lossless. Lossless compression reduces bits by identifying and eliminating statistical redundancy. No information is lost in lossless compression. Lossy compression reduces bits by removing unnecessary or less important information. Typically, a device that performs data compression is referred to as an encoder, and one that performs the reversal of the process (decompression) as a decoder. Data compression may be subject to a space-time complexity trades off. For instance, a compression scheme for videos may require expensive hardware for the video to be decompressed fast enough to be viewed as it is being decompressed, and the option to decompress the video in full before watching it may be inconvenient or require additional storage. Video data may be represented as a series of still image frames. Such data usually contains abundant amounts of spatial and temporal redundancy. Video compression algorithms attempt to reduce redundancy and store information more compactly.

With continued reference to FIG. 1, receiving user experience data 186b may further include processing user experience data 186b using optical character recognition. This may align with processes previously described in the context of receiving entity profile 118.

With continued reference to FIG. 1, receiving user experience data 186b may include receiving user experience data 186b through an experience smart assessment. As used in this disclosure, a “smart assessment” is a set of requests or questions that asks for a user's information, such as user experience data 186b, wherein each question contains requests that are specific to the particular data that is being requested. For example, a financial smart assessment may contain questions that are geared towards one's finances, whereas an activity smart assessment may contain questions geared towards one's activities. An “experience smart assessment” for the purposes of this disclosure is a smart assessment that is configured to receive user experience data 186b. For example, experience smart assessment may include questions or prompts such as “explain your recent experience in detail,” “how did the experience make you feel?” “at the moment, what actions did you take?” and the like. In some embodiments, questions or prompts within smart assessment contain open ended questions, or a free input, in which a user is required to answer. In some embodiments, Smart assessment may include a question or prompt followed by a plurality of answers in which a user may select from. The plurality of answers may be chosen from a drop-down menu. The plurality of answers may be a range of answers, in which a user may be required to select the range that falls within their desired input. In some embodiments, plurality of answers may contain a sliding scale in which a user may slide the scale to the preferred numerical result. In a non-limiting example, smart assessment may include a question asking the user a question regarding a recent experience of a user; wherein the question may ask “How did you feel after the action?” Continuing with the example, the user may input their emotion from a plurality of answers. In some embodiments, Smart assessment may take the form of an interview, a report, an interactive software, a virtual meeting or interview, event monitoring, and the like thereof. In some embodiments, smart assessment may include data submission of one or more documentations from the user as described above. In some cases, smart assessment may include a chatbot. For the purposes of this disclosure a “chatbot” is a computer program that simulates and processes human conversation. Chatbot may interact with a user in order to receive user experience data 186b. In some cases, chatbot may simulate a human in order to receive user experience data 186b through a conversation that occurred with the user. As opposed to ordinarily typing in information, a chatbot may engage and stimulate a user such that a user may properly input information and not feel bored or discouraged from doing so. Chatbot is described in further detail below. In some cases, smart assessment may include a plurality of questions or requests wherein the plurality of questions or requests are related to a plurality of topics related to user experience data 186b or any other data as described in this disclosure.

Still referring to FIG. 1, smart assessment may include one or more event handlers. An “event handler” as used in this disclosure is a callback routine that operates asynchronously once an event takes place. Event handlers may include, without limitation, one or more programs to perform one or more actions based on user input, such as generating pop-up windows, submitting forms, requesting more information, and the like. For example, an event handler may be programmed to request more information or may be programmed to generate messages following a user input. User input may include clicking buttons, mouse clicks, hovering of a mouse, input using a touchscreen, keyboard clicks, entry of characters, entry of symbols, an upload of an image, an upload of a computer file, manipulation of computer icons, and the like. For example, an event handler may be programmed to generate a notification screen following a user input such as inputting characters into a computer. In some embodiments, an event handler may be programmed to request additional information after a first user input is received. In some embodiments, an event handler may be programmed to generate a pop-up notification when a user input is left blank. In some embodiments, an event handler may be programmed to generate requests based on the user input.

In continued reference to FIG. 1, in an embodiment, at least a processor 108 may be further configured to identify at least one learning datum 186c as a function of a user experience. “Learning datum” for the purposes of this disclosure is data relating to an educational understanding of an action or event as described above and/or in user experience data 186b. “Educational understanding” for the purposes of this disclosure is knowledge and/or insights with regards to a specific action or event that may allow one to make more informed decisions in the future. For example, a user may have an educational understanding of an embarrassing event, wherein the user may make informed decisions or actions in similar future events. In an embodiment, learning datum 186c may refer to knowledge and/or actions about particular events that occurred or are associated with events or actions in user experience data 186b. In some embodiments, learning datum 186c may include data related to users' previous knowledge, skill level, learning preference, learning environment, learning methodology, instructional material, user assessment tool, and the like in performing actions, identified from user experience data 186b. In some cases, learning datum 186c may include the actions or steps taken during the event. For example, learning datum 186c may indicate how a user responded to a specific event and what they learned after the event. In a more specific example, learning datum 186c may include a user's mischaracterizations during a financial event that ended in financial loss. Continuing the example, learning datum 186c may further include what the user had learned as a result of the mischaracterization and the financial loss. In some cases, learning datum 186c may include positive learning datum 186c. “Positive learning datum” for the purposes of this disclosure is a learning datum 186c configured to enhance the learning experience of a user. In some embodiments, positive learning datum 186c may include various types of data that indicate progress or success in performing actions described above. For example, positive learning datum 186c may include data relating to increased financial awareness, increased financial security, or increased financial wealth as a result of an action or event involving finances. Positive learning datum 186c may include any positive action, experience, or result at occurred as a result of a user experience in user experience data 186b. In some embodiments, learning datum 186c may include negative learning datum 186c. “Negative learning datum” for the purposes of this disclosure is learning datum 186c configured to identify areas where the user is struggling or experiencing difficulty. In some embodiments, negative learning datum 186c may include various types of data that indicate a lack of progress or understanding, gaps in knowledge or skills, and the like in performing actions described above. In some cases, negative learning datum 186c may further include negative repercussions as a result of an action or event as described above. In a non-limiting example, negative learning datum 186c may include decreased health, decreased health awareness and the like in relation to an action or event involving health. In some cases, identifying at least a learning datum 186c may include receiving learning datum 186c from a user. Learning datum 186c may be received by user interface 120. Learning datum 186c may be received through any means and through any input device as described above.

With continued reference to FIG. 1, identifying learning datum 186c as a function of user experience data 186b may further include identifying learning datum 186c within user experience data 186b. For example, user experience data 186b may include data which may indicate that a user has an increased financial awareness as a result of the action or event wherein computing device 104 may identify the increase in financial awareness as learning datum 186c. Learning datum 186c may be identified using a classifier. A classifier may be configured to output learning datum 186c that labels or otherwise identifies a set of data that are clustered together, found to be close under a distance metric as described below, or the like. For example, a classifier may receive user experience data 186b and output a label that can be used to categorize user experience data 186b into bins or categories, such as a learning category and/or a positive learning category and/or a negative learning category. Learning datum 186c may then include data associated with one or more groupings within user experience data 186b. In an embodiment, at least a processor 108 may generate the classifier using a classification algorithm, which may include a process whereby at least a processor 108 derives a classifier from training data. Training data may include a plurality of user experience data 186b that is correlated to a plurality of step classes. “Step class” for the purposes of this disclosure is a grouping of data relating to each sequence of events surrounding the action or event an event. As a non-limiting example, step class may include a pre-action category (for example this may include actions taken before the event), an action category (for example this may include the actions taken during the event), a post action category (for example this may include actions taken after the event) a learning category (for example this may include what a user may have learned), a growing category (for example this may include how the user grew as a result of the event), an effect category (for example this may include what effects results due to the action or event) and the like. In an embodiment, training data may indicate that particular elements within user experience data 186b may be correlated to particular step classes. In an embodiment, training data may correlate elements within user experience data 186b to a learning category, wherein the elements within the learning category may be added to learning datum 186c. In an embodiment, data associated with one or more grouping of elements within user experience data 186b may comprise learning datum 186c. In some cases, learning datum 186c may include data within user experience data 186b that has been classified into learning categories. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. In some cases, identifying learning datum 186c as a function of user experience data 186b may include using a text search algorithm and/or a string search algorithm (also known as a string match algorithm) to identify a plurality of trigger words, or strings (a sequence of characters used to represent text), wherein the plurality of trigger words or strings may be used to “search” for learning datum 186c. For example, text search algorithm may contain a string such as “more money” wherein the string present within user experience data 186b may indicate that a user has increased financial security. A text search algorithm may be used to search for key words or trigger words wherein the key words or trigger words may be used to identify learning datum 186c within user experience data 186b. In another non-limiting example, a key word or trigger word of “bruised” or “hurt” may indicate that a user was hurt as a result of the action or event. This experience may be categorized as negative learning datum 186c wherein a user struggled or faced difficulty. As used herein a “trigger word” or “key word” is a word or a particular sequence of words that may be searched for in a given data. For example, a text search algorithm may include a trigger word such as “depressed” or “depression” wherein the presence of such a trigger word within user experience data 186b may signify that a user had a negative experience. Text search algorithm may include a plurality of trigger words wherein each trigger word may be associated with learning datum 186c. The trigger words may be input by a user such as a life coach, an ordinary user, a third party or any party that has an interest in system 100. The trigger words may be retrieved from a database. In some cases, the trigger words may be generated based on previous iterations. In some cases, learning datum 186c may include an intensity score wherein the intensity score indicates how prevalent a particular trigger word is. For example, the presence of a particular string such as “sad” found multiple times with user experience data 186b may indicate that a user has heightened negative emotions as a result of a particular event. As a result, data relating to heightened negative emotions may have a higher intensity score within learning datum 186c. Intensity score may be generated based on predetermined data that correlates the presence of a particular word and the number of times it is mentioned to a particular score. For example, predetermined data may indicate that the presence of the word “sad” between 10 and 12 times within user experience data 186b may correlate to an intensity score of 70 wherein the score is calculated on a range of 1-100.

With continued reference to FIG. 1, identifying learning datum 186c as a function of user experience data 186b may include receiving the at least a learning datum 186c from a user through a learning smart assessment. “Learning smart assessment” for the purposes of this disclosure is a smart assessment configured to receive learning datum 186c. Learning smart assessment may include questions, surveys or prompts related to learning datum 186c. As described above, user may input data through a series of questions and the like within learning smart assessment. Generating learning smart assessment as a function of user experience data 186b may include classifying user experience data 186b to one of a plurality of experience categories and generating at least one learning smart assessment as a function of the user experience data 186b and one of the pluralities of experience categories. Additionally, or alternatively, learning smart assessment may be generated as a function of user experience data 186b, wherein a particular set of questions within learning smart assessment may be chosen from a plurality of questions, wherein the particular set of questions may relate to the activity or event described in user experience data 186b. For example, learning smart assessment may include questions relating to job loss when user experience data 186b indicates that a user recently lost their job. Computing device 104 may choose the particular set of questions by classifying data within user experience data 186b to a particular group, wherein each particular group may be associated with a particular set of questions. For example, when elements of user experience data 186b are classified to a job loss group, learning smart assessment may include questions relating to job loss such as “what did you do after you lost your job?” and “how did you budget after losing your job?” Learning smart assessment may be generated by selecting questions from a database containing a plurality of questions. The plurality of questions may be generated by a user, previous iterations and any other way as described in this disclosure.

A classifier may be configured to output an event category that labels or otherwise identifies a set of data that are clustered together, found to be close under a distance metric as described below, or the like. For example, a classifier may receive user experience data 186b and output datum that can be used to categorize data within user experience data 186b into bins or categories, such a financial category, a health category, a job loss category and the like. Questions may then be retrieved using a lookup table. For example, a category pertaining to a financial event may contain data within a lookup table of question relating to the particular event. The lookup table may be retrieved from a database and/or generated by a user. In some embodiments, at least a processor 108 may “look up” a given category to one or more lists of questions. At least a processor 108 may generate the classifier using any algorithm for the purposes of this disclosure. In some cases, generating the learning smart assessment as a function of user experience data 186b may include generating learning smart assessment using a machine-learning model.

With continued reference to FIG. 1, in some embodiments, system 100 may be further configured to modify optimized apportionment data 180d using a post-action machine-learning model 186d. As used herein, a “post-action machine-learning model” is a model trained to analyze post-event insights, such as learning datum 186c derived from user experience data 186b, to adapt and refine resource distribution strategies. At least a processor 108 may input the at least one learning datum 186c into the post-action machine-learning model 186d, wherein the model outputs a modification to one or more elements of the optimized apportionment data 180d. In a non-limiting example, the learning datum 186c may indicate a user's improved response to stressful social situations, derived from past experience data and classified as positive learning. In such an example, the post-action machine-learning model 186d may assign the user a broader or more public-facing set of operational functions than previously recommended, thus modifying the prior apportionment. In another example, if the learning datum 186c reveals continued negative patterns or limited growth in a financial decision-making context, the system may shift or restrict high-impact financial tasks from the user's workload in the updated apportionment. These adjustments allow for continual adaptation of function assignment based not only on performance metrics and constraints, but also on deeper, experience-informed insights tied to personal growth, challenges, and contextual behavior.

In further reference to FIG. 1, in some cases, modifying the optimized apportionment data 180d may further include using a feedback mechanism wherein outputs of the post-action machine-learning model 186d are stored in a training dataset for future iterations. This may enable system 100 to evolve its understanding of how different types of learning datum 186c, categorized into positive and negative, or growth-based versus trauma-based, impact long-term task performance and resource needs. In this way, system 100 may develop individualized models of development that inform future resource distribution decisions, further aligning with entity's profile, objective group classification, and long-term target function 140.

In continued reference to FIG. 1, in an embodiment, one or more aspects or implementations of first module 172a may align with one or more embodiments described in Attorney Docket No. 1452-013USU1, U.S. Pat. No. 12,008,409, filed on May 2, 2023, titled “APPARATUS AND A METHOD FOR DETERMINING RESOURCE DISTRIBUTION,” Attorney Docket No. 1452-010USU1, U.S. Pat. No. 12,260,308, filed on May 2, 2023, titled “APPARATUS FOR POST ACTION PLANNING AND METHOD OF USE,” Attorney Docket No. 1452-009USU1, U.S. patent application Ser. No. 18/142,536, filed on May 2, 2023, titled “APPARATUSES AND METHODS FOR ACTUALIZING FUTURE PROCESS OUTPUTS USING ARTIFICIAL INTELLIGENCE,” and Attorney Docket No. 1452-002USU1, U.S. patent application Ser. No. 18/142,905, filed on May 3, 2023, titled “METHOD AND AN APPARATUS FOR SCHEDULE ELEMENT CLASSIFICATION,” each of which are incorporated by reference herein in their entirety.

With further reference to FIG. 1, in an embodiment one or modules 152 of modular suite 156 may include a second module 172b configured to determine a growth factor. As used in this disclosure, “growth factor” is a characteristic or feature of an entity that limits its ability to grow. In some cases, a limit of an ability to grow may be a result of previous growth, additional factors that affect growth as an entity becomes larger, or the like. In some embodiments, a product design, a feature of an entity, or a process for manufacturing an entity's product may limit the entity's efficiency as the entity grows. For example, growth factor may limit high quantity production, high quality production, fast transport, increased advertisement, research and development, revenue, profit, workforce, and things of the like. In some embodiments, growth factor may include a single characteristic. In another embodiment, growth factor may include a combination of characteristics. As a non-limiting example, growth factor may include a manufacturer not being able to produce a desired volume. In another non-limiting example, growth factor may include a wholesaler having an insufficient amount of material in combination with a manufacturer not being able to produce a desired volume. In some embodiments, growth factor may include a temporal element 190c. In some instances, an entity may review different factors that have enabled the entity's growth in the past. A temporal element 190c may include a historical time element (e.g., 1 month ago, 2 months ago, 6 months ago, 1 year ago). In some instances, growth factor may include a combination of factors in view of a timing element. For instance, growth factor may include factors that assisted an entity in growing their enterprise, business, operation, or the like by a certain amount (e.g., 2-fold, 5-fold, 10-fold). In some embodiments, growth factor may be indicative of principles (i.e., behaviors, activities, methodologies). In some embodiments, identifying a growth factor may include utilizing a machine learning process and/or model as described in further detail below. Utilizing machine-learning model may include inputs, including but not limited to, a size of entity, past growth of entity, unique ability, or things of the like, to output a growth factor. A unique ability may be described in further detail in U.S. Pat. No. 12,175,341, filed on May 1, 2023, entitled “APPARATUS AND A METHOD FOR HIGHER-ORDER GROWTH MODELING,” the entirety of which is incorporated by reference. Growth and scaling predictions, and methods therefor, may be described in further detail in U.S. Pat. No. 11,868,859, filed on Apr. 28, 2023, entitled “SYSTEMS AND METHODS FOR DATA STRUCTURE GENERATION,” the entirety of which is incorporated by reference.

In an embodiment, determining a growth factor may include receiving, at second module 172b, resource distribution from first module 172a. The resource distribution may be generated by the first module 172a as described above, and may include optimized apportionment data 180d, entity profile 118 data, constraint data, and one or more function assignments generated as a function of time cost, assignable function analysis, and future process output 184a alignment. In some embodiments, the second module 172b may receive the resource distribution through a direct module-to-module data transfer mechanism, wherein the first module 172a outputs the resource distribution in a standardized format compatible with the second module's 172b input interface. The resource distribution may be transmitted as a structured data object, such as a serialized packet, JSON object, protocol buffer, or another machine-readable format. In an embodiment, at least a processor 108 may facilitate the transfer of data between the modules using an internal messaging system or shared memory interface configured for intra-system communication within modular suite 156. In some cases, the resource distribution may be timestamped or versioned to ensure synchronization between module operations, particularly in asynchronous or real-time systems. In an embodiment, second module 172b may include one or more verification processes configured to confirm receipt and integrity of the resource distribution data. For example, the second module 172b may perform a hash check, schema validation, or semantic check to ensure the incoming data contains valid and expected elements, such as apportionment data 180c tagged by function ID, available resource totals, and objective group alignment markers. In some embodiments, the receipt of resource distribution may trigger an event handler or callback routine within the second module 172b to initiate the determination of a growth factor based on the incoming data. The modular architecture thereby ensures that the second module 172b operates reactively to the outputs of the first module 172a, enabling a seamless and intelligent handoff between distinct phases of system analysis.

In continued reference to FIG. 1, in an embodiment, determining a growth factor may include determining a growth constraint profile 190a including at least one characteristic affecting a growth ability of the entity and a temporal element 190c. As used in this disclosure, a “growth constraint profile” is a structured representation of data that characterizes the limitations or inhibitors to growth for an entity over a defined timeframe. The characteristic affecting growth 190b ability may include, without limitation, resource availability, operational bottlenecks, distribution inefficiencies, workforce limitations, technological constraints, regulatory burdens, market saturation indicators, or any parameter indicative of a reduced capacity to scale operations or outcomes.

With further reference to FIG. 1, in an embodiment, determining the growth constraint profile 190a may include receiving a plurality of data points associated with the entity, such as current resource distribution data, operational data 192a, historical performance trends, and external market indicators. Processor 108 may extract constraint-related features using one or more analytical processes including threshold-based assessments, statistical analysis, or classification algorithms. The temporal element 190c of the growth constraint profile 190a may include timestamps, event sequences, or categorized time intervals (e.g., short-term vs. long-term constraints), and may further account for seasonality, historical periods of stagnation, or forecasted downturns. For example, a characteristic such as “manufacturing throughput delay” may be identified as a constraint during Q2 of a fiscal year based on historical shipping delays and seasonal demand spikes and may be tagged accordingly in the profile. In this way, system 100 enables dynamic evaluation of how constraints vary over time, thereby allowing growth factor determination to be both context-sensitive and temporally responsive.

In an embodiment, determining the growth constraint profile 190a may further include analyzing at least one entity process associated with the entity. These processes may include, without limitation, customer onboarding procedures, product delivery cycles, talent acquisition routines, service deployment protocols, or sales funnel mechanics. In some embodiments, the structure, complexity, or maturity of one or more entity processes may directly affect the entity's ability to grow. For example, if an entity process for onboarding new clients requires excessive manual intervention or lacks scalability, it may be classified as a constraint within the growth constraint profile 190a, particularly if correlated with high resource costs or time delays. At least a processor 108 may be configured to analyze historical or real-time data associated with entity processes, such as duration metrics, resource utilization trends, failure rates, or process deviation logs, to identify characteristics that inhibit growth. These characteristics may be integrated into the constraint profile either directly or through feature extraction techniques applied to process analytics. The temporal element 190c may then be aligned with the evolution of the entity process over time, capturing how procedural maturity or optimization has trended and forecasting how further process improvement may impact growth readiness. In this way, the entity process acts as both a source of constraint indicators and a lever for growth factor enhancement, enabling the system to dynamically adapt recommendations as operational processes evolve.

In further reference to FIG. 1, in some embodiments, growth constraint profile 190a may be used by second module 172b to contextualize the growth factor within the practical limits of the entity's operations. For example, the second module 172b may compare the growth constraint profile 190a against proposed opportunities or predictive growth paths derived from future process outputs 184a or learning datum 186c to determine feasibility scores or likelihoods of success. In an embodiment, at least a processor 108 may assign weighted values to various characteristics within the growth constraint profile 190a, thereby influencing the selection or ranking of one or more growth factors based on temporal readiness or operational capacity. If a constraint is identified as transient, such as a short-term staffing shortage, system 100 may still recommend an aggressive growth factor, while flagging the need for mitigation strategies in a concurrent module. Conversely, if a constraint is persistent or long-term, such as market saturation, system 100 may deprioritize growth factors involving market expansion in favor of internal optimization or diversification strategies. Additionally, growth constraint profile 190a may be shared across modular suite 156 to inform the activation or behavior of other modules. For instance, a constraint associated with resource utilization may be forwarded to the first module 172a to trigger a re-evaluation of resource distribution, or it may be passed to an exploitation module to guide risk-averse strategies. In this way, growth constraint profile 190a acts not only as an analytical output but as a shared operational input across intelligent modules, promoting coherent and constraint-aware decision-making throughout the system.

With further reference to FIG. 1, in an embodiment, at least a processor 108 may be further configured to generate strategy data as a function of one or more elements including the growth factor, growth constraint profile 190a, resource distribution, learning datum 186c, and at least one entity process. As used in this disclosure, “strategy data” refers to a data structure or set of decision-oriented parameters that outline a proposed course of action, operational adjustment, or opportunity path designed to promote entity advancement while accounting for constraints and contextual insights. Strategy data may be generated by synthesizing growth opportunities identified by the second module 172b with operational feasibility determined from the constraint profile and resource distribution. In a non-limiting example, if the growth factor suggests expanding into a new service domain, but the constraint profile highlights limited qualified personnel and the entity process reflects slow onboarding, the strategy data may include an interim recommendation for talent development or partnership exploration before activation of the new domain. In some embodiments, the strategy data may further integrate learning datum 186c derived from user experience data 186b, thereby tailoring strategic outputs not only to structural or resource-based factors, but also to user development and historical behavior. For example, if the learning datum 186c indicates a user has recently developed financial decision-making acumen, strategy data may recommend initiatives or resource reallocations that place the user in a leadership or budget management role. Strategy data may also include confidence scores, execution timelines, or risk flags associated with each recommendation, and may be formatted for use across multiple modules, such as the exploitation module for execution planning, or the collaboration module for partner matching based on strategy alignment. In this way, strategy data serves as a central coordination artifact that encapsulates growth potential, operational reality, and individual evolution into an actionable framework.

In continued reference to FIG. 1, in an embodiment, one or more aspects or implementations of second module 172b may align with one or more embodiments described in Attorney Docket No. 1452-003USU1, U.S. Pat. No. 11,995,811, filed on May 3, 2023, titled “METHOD AND APPARATUS FOR DETERMINING A GROWTH FACTOR,” which is incorporated by reference herein in its entirety.

In further reference to FIG. 1, in an embodiment, one or more modules 152 of modular suite 156 may include a third module 172c configured to generate exploitation data 192c. As used herein, “exploitation data” refers to data generated for the purpose of maximizing utility, efficiency, profitability, or collaborative potential of resources, operations, or strategies associated with one or more entities. Exploitation data 192c may include, for example, suggested actions, task allocations, temporal windows for opportunity, resource synergies, or collaborative recommendations, all aimed at enhancing operational yield based on current and predictive states. In an embodiment, exploitation data 192c may include capitalizing on one or more free zones within environment selection 136. Capitalizing may include examining the viability of one or more entities inserting themselves into the underserved market. This may be done to identify opportunities to gain market share and to maximize profits. Capitalizing on free zones may involve identification of leveraging the opportunities presented by the market gap to maximize business growth and profitability. Exploitation data 192c may include one or more suggestions of what is needed from one or more entities to capitalize on the free zones. This may include an identification of one or more traits or attributes of an entity that will allow the entity to capitalize on the free zone within environment selection 136. Examples of traits/attributes may include infrastructure, types of personnel, quantity of personnel, equipment needed, subject matter expertise needed, marketing strategies, adaptation of goods/services for a new market, and the like. In a non-limiting example, demand data 192b may identify that the demand for a given product is at 20 million dollars per year nationwide. Additionally, demand data 192b may include an identification of a free zone within the market which identifies an underserved foreign geographic location within the market. Given the demand data 192b at least a processor 108 may generate exploitation data 192c which identifies several traits of an entity that are needed to provide goods or services to the foreign geographic location. These traits may include having a supply chain and infrastructure within the foreign geographic location. In other embodiments, exploitation data 192c may include an identification of types of goods/products that are in demand according to demand data 192b. This may include the specific attributes of the goods/services that are in demand. Attributes may include traits like free delivery, high end materials, high/low price point, availability within a geographic location, and the like. Exploitation data 192c may be generated by providing an indication of what is needed to access the free zone in environment selection 136. Processor 108 may compare the current free zone and demand data 192b to historical versions of exploitation data 192c to generate a current version of exploitation data 192c.

In some embodiments, generating exploitation data 192c may comprise receiving a plurality of entity profiles 118. Each entity profile 118 may include operational data 192a, which for the purposes of this disclosure may include, but is not limited to: current resource allocations, employee capacity, throughput rates, time constraints, productivity metrics, financial conditions, digital footprints, or any other data describing operational states and capabilities. A plurality of entity profiles 118 may include a first entity profile and a second entity profile, wherein the first entity profile and the second entity profile are both entity profiles 118 as defined herein above. The first entity profile may be associated with a first entity, whereas the second entity profile may be associated with a second entity. In a non-limiting example, the entity profile 118 may be consistent with or substantially consistent with the user profile described in Attorney Docket No. 1452-001USU1, U.S. patent application Ser. No. 18/141,320, filed on Apr. 28, 2023, titled “METHOD AND AN APPARATUS FOR ROUTINE IMPROVEMENT FOR AN ENTITY,” which is incorporated by reference herein in its entirety.

With continued reference to FIG. 1, each entity profile 118 of the plurality of entity profiles 118 may include a plurality of operational data 192a. As used in the current disclosure, “operational data” is information that describes the operations of the entity. The operations of a business may include any tasks or jobs that are executed on behalf of the entity. Operational data 192a may also refer to information generated and collected during the day-to-day operations of an organization. Operational data 192a includes various types of data that are crucial for the functioning and decision-making processes within an entity. Operational data 192a may include information about the entity's sales, production, customer interactions, supply chain, human resources, marketing, website, social media, operational efficiency, strengths, weaknesses, industry, and the like of an entity. Operational data 192a may comprise an indication of the industry of the entity. Operational data 192a may additionally include an indication of the current operational capabilities of the entity. As used in the current disclosure, “operational capabilities” are described as the ability of the entity generate products or provide services. The operational capabilities of an entity may include the entity's capacity, resources, and skills to effectively carry out its day-to-day activities and achieve its operational objective. Operational capabilities may include the infrastructure of the entity. Infrastructure may include any physical and technological assets, facilities, and resources that support the entity's operations. This includes buildings, equipment, machinery, IT systems, communication networks, and other necessary infrastructure. Operational Capabilities may also include an indication of the processes and procedures of the entity. This includes how tasks are structured, coordinated, and executed within the organization to achieve efficiency, quality, and compliance with relevant standards or regulations. Operational capabilities of an entity may include information regarding the supply chain of the entity. This may include the entity's ability to manage the flow of materials, products, and services throughout its supply chain. This involves procurement, inventory management, logistics, supplier relationships, and coordination to ensure timely and cost-effective delivery of goods or services. Operational data 192a may include information regarding the quality of the goods and services provided by the entity. This may include an indication of a price point of the goods and services and where that price point falls within the overall marketplace. The entity's commitment to maintaining and improving the quality of its products, services, and operational processes. This includes quality control measures, quality assurance systems, compliance with industry standards or certifications, and continuous improvement initiatives. Operational data 192a may be used for analysis, reporting, and decision-making purposes. By analyzing this data, organizations can gain insights into their operations, identify patterns, detect anomalies, and make informed decisions to improve efficiency, optimize resources, and enhance customer satisfaction.

In an embodiment, processor 108 may be configured to identify demand data 192b as a function of the plurality of entity profiles 118. For the purposes of this disclosure, “demand data” refers to data representing a quantified or qualified need for a product, service, action, or resource. For example, demand data 192b may include internal data to the system and/or externally determined from market or contextual signals. Demand data 192b may be inferred using classification algorithms or demand modeling techniques that evaluate inter-entity dependencies, scarcity patterns, prior engagement success rates, or predictive economic indicators derived from entity profiles 118. In an embodiment, demand data 192b may be calculated for the entire market or for one or more goods or services that are provided. Additionally, demand data 192b may be calculated using sales data from the retailers and service providers who are present in the market. Demand data 192b may be calculated using several factors including the price range for the goods and services, consumer preferences, target groups, target group income levels, consumer trends, market competition, and the like. Demand data 192b may include a description of the demand for goods and services within a geographic area. Demand data 192b may include information relating to demographics of the people or companies who have a demand for the goods or services. In an embodiment, demand data 192b may be described as a monetary value of the market. The monetary value of the market may be described as the sum of the value of the goods and services that have been provided. Demand data 192b may include a prediction of the monetary value of the market at various time intervals. Determining the value of the market demand may involve assessing the market size, market growth, market growth rate, market growth potential, profit margins, and other relevant factors. In an embodiment, at least a processor 108 may be configured to determine demand using cookies or website views. In an embodiment, at least a processor 108 may be configured to insert a tracking code into the web pages where you want to track clicks and page views. This code typically consists of JavaScript or HTML snippets that collect data when users interact with your website. This may include setting up event tracking to capture clicks on specific elements or actions that indicate user demand. For example, you might track clicks on buttons, links, or form submissions. When a user performs a click action, the tracking code will send a request to the analytics tool with relevant information. The tracking code should also automatically capture page view data whenever a user visits a page on your website. It usually records details like the page URL, referring source, and timestamps. Processor 108 may be configured to count the number of views, searches, clicks, inquiries, and the like to determine the demand data 192b.

With continued reference to FIG. 1, demand data 192b may include a demand scope. As used in the current disclosure, a “demand scope” is an identification of the industry or market segment that is associated with the demand. Demand scope may include an identification and segmentation of the market based on relevant characteristics such as geography, demographics, customer behavior, or product/service attributes. This segmentation may aid system 100 in understanding the specific demand patterns within different market segments. In an embodiment, processor 108 may determine the market scope based on the operational data 192a associated with the entity profile 118. More specifically, demand scope may be determined based on the industry of the entity and the operational capabilities. For example, an entity is currently a mining company the market scope may be limited to mining products and biproducts. In an embodiment, at least a processor 108 may generate demand data 192b as a function of the market data. Processor 108 may collect relevant market data that provides insights into the demand drivers for the industry. Market data may include market research reports, industry surveys, government publications, trade associations' data, customer surveys, or any other reliable sources of information. In some embodiments this information may be gathered using a web crawler. Demand data 192b may include an analysis of economic indicators. This may include an analysis of macroeconomic indicators that can influence industry demand. Factors such as GDP growth, population trends, employment rates, inflation, consumer spending, and government policies can impact the overall demand for goods and services within an industry. In some embodiment, demand data 192b may include an analysis of the competitive landscape within a given industry. This may include an identification of the players within the market and their market share. This may include an identification and analysis of the market share and growth rates of key competitors, identifying any emerging players or disruptive technologies, and considering the impact of industry-specific factors like barriers to entry, regulatory environment, and customer preferences.

With continued reference to FIG. 1, demand data 192b may include an identification of one or more free zones within environment selection 136. As used in the current disclosure, a “free zone” is a segment or area of the market that has not been fully explored or developed by entities. A free zone may include information about the goods and service providers within environment selection 136. This may include a description of the market share of each provider. In some embodiments, a free zone may include an identification of a target group for the goods and services or the target group for each provider. As used in the current disclosure, a “target group” refers to the characteristics of a population or specific consumer segments based on various factors such as age, gender, income, education, occupation, marital status, ethnicity, and geographic location. Target group information provides insights into the composition and preferences of consumer groups, enabling entities to understand and target their products or services more effectively. A free zone may represent a potential customer base or business opportunity that has yet to be targeted or served effectively. The concept of a free zone implies that there is a demand or need that has not been adequately addressed, leaving room for new entrants or existing businesses to capture market share and generate growth. Identifying a free zone may require an analysis of the demand data 192b to understand consumer needs, preferences, and unmet demands. Identifying a free zone may include an identification of a target group such as specific age ranges, ethnicities, or geographic areas, may have unique needs and preferences that are not fully catered to by existing products or services. A free zone may additionally include an identification of new industries or technologies that are still in their early stages and may present untapped market opportunities. These markets may lack established players or comprehensive solutions, leaving room for innovation and market entry. In some embodiments, identification of a free zone may include an identification of niche markets. Niche markets may be a specialized segment of the market with specific needs and preferences. They may be underserved or overlooked by mainstream businesses, creating opportunities for companies that can effectively target and cater to those niches. In other embodiments, the identification of a free zone may include the identification of new geographic regions, either domestically or internationally, which can open up untapped markets. Different regions may have unique cultural, economic, or regulatory factors that create opportunities for new products or services.

With continued reference to FIG. 1, in an embodiment, at least a processor 108 may generate, using demand data 192b, a demand machine-learning model. As used in the current disclosure, an “demand machine learning model” is a machine-learning model that is configured to generate demand data 192b. The demand machine-learning model may be consistent with machine-learning models as described throughout this disclosure. Inputs to the demand machine-learning model may include entity profile 118, entity data, operational data 192a, examples of demand data 192b, and the like. Outputs to the demand machine-learning model may include demand data 192b tailored to the entity profiles 118 and/or an indication of free zones. Demand training data is a plurality of data entries containing a plurality of inputs that are correlated to a plurality of outputs for training a processor by a machine-learning process. In an embodiment, demand training data may include a plurality of entity profiles 118 correlated to examples of demand data 192b. Demand training data may be received from a database. Demand training data may contain information regarding entity profile 118, entity data, operational data 192a, examples of demand data 192b, and the like. In an embodiment, a demand machine-learning model may be iteratively updated with the input and output results of past demand machine-learning models. The machine-learning model may be performed using, without limitation, linear machine learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model.

Continuing the embodiment, the third module 172c may be further configured to generate exploitation data 192c as a function of both operational data 192a and demand data 192b. In an embodiment, at least a processor 108 may use statistical modeling techniques to analyze the data collected and develop a predictive model for generating the exploitation data 192c. As used in the current disclosure, a “predictive model” is a mathematical or statistical model that is designed to predict the outcome of a specific event or phenomenon. A predictive model may be used to provide insights and predictions that can be used to inform decision-making and improve outcomes. Predictive models use historical data to identify patterns and trends that can be used to predict future outcomes. A predictive model may be configured to receive an input such as an entity profile 118, operational data 192a, demand data 192b, demand scope, free zones, examples of exploitation data 192c, and the like. A predictive model may be configured to output exploitation data 192c that is tailored to the demand data 192b. The predictive model may use historical and current versions of the inputs to make accurate predictions about future incidents and the cost associated with those events. In some embodiments, a predictive model may be configured to clean and process the input to ensure its accuracy and consistency. This step involves identifying and correcting errors, removing duplicates, and converting data into a usable format. Processor 108 may then be configured to choose an appropriate model or algorithm that can effectively predict the outcome. This may involve selecting a model that is suitable for the data set, and that has a good balance between accuracy and interpretability. This may include an algorithm or machine-learning model described herein including an exploitation machine-learning model 192e as mentioned herein below.

With continued reference to FIG. 1, in an embodiment, at least a processor 108 may generate exploitation data 192c using an exploitation machine-learning model 192e. As used in the current disclosure, an “exploitation machine-learning model” is a machine-learning model that is configured to generate exploitation data 192c. The exploitation machine-learning model 192e may be consistent with machine learning models as described throughout this disclosure. Inputs to the exploitation machine-learning model 192e may include entity profile 118, entity data, operational data 192a, demand data 192b, demand scope, free zones, examples of exploitation data 192c, and the like. Outputs to the exploitation machine learning model may include an exploitation data 192c tailored to the free zones. Exploitation training data is a plurality of data entries containing a plurality of inputs that are correlated to a plurality of outputs for training a processor by a machine-learning process. In an embodiment, exploitation training data may include a plurality of operational data 192a correlated to examples of exploitation data 192c. In another embodiment, exploitation training data may include a plurality of free zones correlated to examples of exploitation data 192c. Exploitation training data may be received from a database. Exploitation training data may contain information regarding entity profile 118, entity data, operational data 192a, demand data 192b, demand scope, free zones, examples of exploitation data 192c, and the like. In an embodiment, exploitation machine-learning model 192e may be trained with a plurality of data entries containing operational data 192a inputs correlated to exploitation data 192c outputs. The operational data 192a may include, without limitation, entity-specific performance indicators, resource utilization metrics, temporal activity logs, and inter-entity communication patterns, while the exploitation data 192c may include successful collaboration instances, strategic partnership outcomes, market impact assessments, and demand satisfaction rates. Exploitation machine-learning model 192e may use supervised learning techniques to identify statistically significant patterns and relationships between operational behaviors and successful exploitation outcomes. For example, a neural network model may be configured to associate specific operational sequences or temporal activity clusters with high exploitation scores, enabling predictive classification of future exploitation opportunities. In some embodiments, exploitation machine-learning model 192e may be periodically retrained with new data harvested from ongoing operations and external sources to ensure continued accuracy and contextual alignment. Feature extraction processes may be employed to isolate key operational attributes most indicative of favorable exploitation conditions, and these features may be weighted or ranked according to their predictive importance. The resulting model may enable system 100 to recommend or initiate targeted collaboration efforts, resource reallocations, or market engagement strategies based on real-time operational inputs and learned exploitation dynamics. In an embodiment, exploitation machine-learning model 192e may be iteratively updated with the input and output results of past exploitation machine learning models 192e. The machine-learning model may be performed using, without limitation, linear machine-learning models such as without limitation logistic regression and/or naive Bayes machine learning models, nearest neighbor machine-learning models such as k-nearest neighbors machine learning models, support vector machines, least squares support vector machines, fisher's linear discriminant, quadratic machine-learning models, decision trees, boosted trees, random forest machine-learning model.

With continued reference to FIG. 1, exploitation machine-learning model 192e may greatly enhance the functionality of software for generating and improving exploitation data 192c related to a user. By leveraging large datasets and advanced algorithms, exploitation machine learning model can analyze patterns, extract insights, and make accurate predictions based on user behavior and preferences. This may enable system 100 to generate exploitation data 192c that reflects the likelihood or reliability of specific outcomes or recommendations for the user. Through continuous learning and adaptation, exploitation machine-learning model 192e may dynamically update the exploitation data 192c based on real-time data. This enables software to provide personalized and contextually relevant results, improving user satisfaction and engagement. Machine learning also enables software to identify and analyze complex relationships and dependencies that may be difficult for traditional rule-based systems to capture. As a result, the generated exploitation data 192c becomes more accurate and reliable, empowering users to make informed decisions based on trustworthy insights and predictions.

Still referring to FIG. 1, exploitation data 192c may further be used to determine collaboration data 192d. As used herein, “collaboration data” refers to data indicating opportunities for two or more entities to work together toward a shared objective, leveraging respective strengths to compensate for individual limitations. Collaboration data 192d may include indicators such as overlap in time availability, shared demand targets, resource complementarity, proximity, or strategic alignment. Determining collaboration data 192d may include using a similarity or clustering algorithm trained on historical cooperative success patterns to output pairings or groups of entities whose joint operation may yield improved outcomes relative to individual action.

With continued reference to FIG. 1, determining the collaboration data 192d includes classifying the plurality of operational data 192a into a plurality of collaboration categories. As used in the current disclosure, an “collaboration category” is a category that is representative of at least one aspect of the collaboration of the entities. Collaboration categories may be generated based on criteria laid out by the exploitation data 192c. In a non-limiting example, exploitation data 192c may describe the need for specialized equipment, 10 personnel, and a warehouse to capitalize on the free zone. The collaboration categories may include categories for financial resources, specialized equipment, personnel members, warehouse space, and the like. Additional, non-limiting examples of collaboration categories may include categories such as personnel, infrastructure, resources, equipment, clientele, financial ability, finances, office space, buildings, structures, expertise, types of goods/products, quality of goods/products, and the like. In an embodiment, at least a processor 108 may be configured to generate a plurality of collaboration categories based on the available entity profiles 118. In an embodiment, at least a processor 108 may generate a plurality of collaboration categories based on historical versions of the collaboration categories. At least a processor 108 may generate a plurality of collaboration categories by extracting relevant features, characteristics, or traits associated with the exploitation data 192c. Identification of features may depend on the nature of the demand data 192b and the requirements set out by the exploitation data 192c. In other embodiments, at least a processor 108 may be configured to receive a plurality of collaboration categories from a database. Processor 108 may pair a first entity profile, and a second entity profile based on the classification of their respective individual operational data 192a into each of the plurality of collaboration categories. The classification may occur if the operational capability of an entity at least partially matches or exceeds the requirements set out by the collaboration categories. Additionally, at least a processor 108 may further classify operational data 192a within the categories as assets or liabilities. In a non-limiting example, the assets/liabilities of an entity may include the quality of the brand's image/reputation, quality of products/services, quality of customer service, location, technology, customer base, and the like. In an embodiment, the classification of a plurality of operational data 192a into a plurality of collaboration categories may be done using a collaboration machine learning model as described herein below.

In continued reference to FIG. 1, in an embodiment, one or more aspects or implementations of third module 172c may align with one or more embodiments described in Attorney Docket No. 1452-039USU1, U.S. Pat. No. 12,147,453, filed on Jan. 10, 2024, titled “APPARATUS AND A METHOD FOR THE GENERATION OF EXPLOITATION DATA,” which is incorporated by reference herein in its entirety.

With continued reference to FIG. 1, in an embodiment, predetermined progression schedule 160 may be progressed as a function of a set of performance thresholds 161 and time-based criteria 162, such that activation of subsequent modules is implemented when the time-series data 164 meets or exceeds predefined metrics. For purposes of this disclosure, “performance thresholds” are pre-established benchmarks or limits set for specific operational metrics. In an embodiment, performance thresholds may serve as indicators of when certain levels of system 100 or user performance have been attained. In some embodiments, performance thresholds may also pertain to a user's performance, such as improvements in personal productivity, efficiency gains, or other individualized performance metrics. For example, system 100 may define thresholds for the time taken to complete a task, error rates, or the rate of improvement in personal workflow efficiencies. When these metrics meet or exceed the predefined thresholds, it may signal that the user has achieved a level of performance that justifies progression to subsequent operational stages or activation of additional functionalities. Continuing, for purposes of this disclosure, “time-based criteria” refer to scheduled time intervals or durations that serve as a temporal benchmark for evaluating system performance. For example, each module of one or more modules 152 may be required to be active for one year before progressively activated the next. Time-based criteria 162 may ensure that performance improvements are sustained over a designated period before additional modules are activated, rather than relying solely on instantaneous measurements. Further, “time-series data,” for purposes of this disclosure, is sequential data collected over time that records the evolution of performance metrics or other system parameters. By capturing data points at regular intervals, time-series data 164 may provide insights into trends and fluctuations in performance, facilitating real-time monitoring and subsequent analysis.

With continued reference to FIG. 1, in an embodiment, system 100 may continuously monitor operational performance of a user by capturing time-series data 164, which includes key metrics relevant to a user's progress. This data may be analyzed in real time, allowing system 100 to detect when performance metrics reach or exceed the predefined thresholds established for efficient operation and progressive activation of subsequent modules. Additionally, system 100 may consider time-based criteria 162, ensuring that observed performance improvements are not merely transient but are sustained over a designated period. Once the time-series data 164 confirms that both the performance thresholds have been met and the necessary time-based conditions have been satisfied, system 100 may trigger the activation of subsequent modules within the modular suite 156. This may ensure that additional functionalities are only engaged when a user has demonstrated consistent and reliable performance, thereby optimizing resource utilization and overall system efficiency. By combining performance thresholds with time-based criteria 162, the embodiment guarantees a robust, data-driven, and temporally validated mechanism for progressive module activation, allowing system 100 to adapt dynamically to operational changes and meet the desired target functions 140 in a measured and strategic manner.

In further reference to FIG. 1, in an embodiment, at least a processor 108 is configured to monitor operational performance by capturing time-series data 164, wherein the time-series data 164 is used to iteratively refine the policy 148 using an adaptive refinement model 168. For purposes of this disclosure, “operational performance” refers to the measurement of how effectively a user interacts with the system and how well those interactions align with the defined target function 140. This may include, for example, quantifiable metrics such as personal productivity improvements, task completion times, error rates, and overall efficiency gains. Essentially, operational parameters may assess the degree to which the user's activities contribute to achieving the intended outcomes of the system and may reflect both the user's performance and the system's ability to facilitate desired behaviors. In an embodiment, time-series data 164 may include sequential performance metrics gathered over time, including measurements of the user's interactions, productivity improvements, and other relevant performance indicators. This continuous collection of data may allow system 100 to track trends and fluctuations in how well the user's performance aligns with the target function 140. The captured time-series data 164 may then be utilized by adaptive refinement model 168, which may iteratively refine the policy 148 governing system 100. As adaptive refinement model 168 analyzes the temporal data, it may identify patterns and correlations that indicate areas of success or potential improvement. Based on these insights, the policy 148 may be dynamically adjusted to optimize the user's performance, ensuring that subsequent modules or functionalities are activated at opportune moments. This feedback loop not only enables real-time adaptation to the user's evolving operational performance but may also enhance the overall system's 100 responsiveness to ensure alignment with the target function 140.

With continued reference to FIG. 1, in an embodiment the adaptive refinement model 168 is configured to perform a series of steps that allow for real-time, comparative performance analysis and recommendation generation. These steps may include receiving operational performance data 184 from multiple users operating within environment selection 136, comparing the user's operational performance data 184 to the performance data from multiple users operating within environment selection 136, and generating a recommendation that enables user to differentiate and enhance a user's position within environment selection 136. In an embodiment, adaptive refinement model 168 may receive operational performance data 184 from multiple users operating within the defined environment selection 136. This data may be gathered using embedded sensors, user interface 120 logging, or dedicated performance tracking modules that record key metrics such as task completion time, error rates, and other relevant performance indicators. In addition to collecting data from users who are directly interacting with system 100, adaptive refinement model 168 can also incorporate performance data from external sources. For example, data may be collected from entrepreneurs or professionals operating outside of system 100 but within the same area of endeavor, such as industry-specific benchmarks, publicly available performance reports, or aggregated data from market research studies. This broader data set enables adaptive refinement model 168 to benchmark individual performance not only against internal peers but also against industry-wide standards, thereby providing a more comprehensive and contextual analysis of operational performance. Data collection in such an embodiment may be implemented using a cloud-based logging service that aggregates performance metrics in real time from both internal users and external data sources. Alternatively, local data collection methods can periodically transmit performance data to a central processing unit, where normalization and integration with external benchmarks are performed. In either case, the resulting time-series data 164 may provide both a real-time snapshot and a historical view of performance, allowing adaptive refinement model 168 to track trends, compare relative performances, and derive insights that drive subsequent recommendations and policy 148 refinements.

Still referring to FIG. 1, in an embodiment, once operational performance data 184 is collected, adaptive refinement model 168 may proceed to compare the data of a specific user against the aggregate performance data from multiple users operating within the same environment. In an embodiment, the comparison process may involve normalizing the data to account for differences in operational conditions or baseline performance. For instance, statistical measures such as percentiles, standard deviations, or z-scores may be used to determine where an individual user's performance stands relative to the group. In another embodiment, a clustering algorithm may be employed to group similar performance profiles, allowing the system to compare a user's metrics with those of peers who have similar operating conditions or roles. Yet another embodiment might use a neural network-based classifier that, after feature extraction from the raw performance data, categorizes users based on performance tiers or specific operational benchmarks. In each case, the goal may include establishing a clear picture of how an individual's performance compares to a broader set of data, providing insight into areas of strength and opportunities for improvement.

With continued reference to FIG. 1, in an embodiment, based on the comparative analysis, adaptive refinement model 168 may then generate a recommendation that enables the user to differentiate and enhance their positioning within the environment selection 136. One embodiment of this step may utilize a multi-layer analysis engine that includes a data aggregation module, a feature extraction module, and a recommendations module. In this scenario, the data aggregation module may compile and normalizes the performance metrics from all users, while the feature extraction module identifies salient characteristics such as patterns of high efficiency or recurring bottlenecks. The recommendations module may then apply a neural network-based decision model or a rule-based engine to determine personalized suggestions. These suggestions could range from targeted training tips to specific system configuration adjustments designed to optimize task execution. Alternatively, in another embodiment, the recommendation engine might leverage a decision tree framework that correlates performance metrics with successful operational strategies, thereby offering step-by-step guidance for improving personal performance. In yet another variant, the system could integrate a feedback loop where the recommendation is dynamically refined based on subsequent performance improvements, ensuring that the guidance remains relevant as conditions evolve.

With further reference to FIG. 1, in an embodiment, adaptive refinement model 168 may include a machine-learning model 169 trained on historical and real-time operational data 192a. In an embodiment, historical data may serve as a foundational dataset, providing a comprehensive record of past performance, user interactions, and environmental conditions. This historical dataset may allow the machine-learning model 169 to learn baseline patterns, identify key performance indicators, and establish relationships between various operational metrics. For example, the model may utilize historical trends to predict future outcomes or to determine the impact of specific performance thresholds on the overall system efficiency. In parallel, real-time operational data 192a may be continuously integrated into the machine-learning model 169, enabling system 100 to dynamically adjust its predictions and refine its policy 148. The incorporation of real-time data may ensure that the machine-learning model 169 remains responsive to current conditions, such as shifts in user behavior, changes in market dynamics, or emerging trends in operational performance. In one embodiment, this real-time integration may be accomplished through continuous data feeds that update the model's inputs at predetermined intervals, ensuring that the adaptive refinement model 168 reflects the latest performance metrics and environmental variables. Multiple embodiments of the machine-learning model 169 may be employed. In one variant, a neural network architecture is used, with an input layer configured to receive time-series data 164, one or more hidden layers that extract and process features from the data, and an output layer that generates updated policies for progressive module activation. Alternatively, ensemble methods such as random forests or gradient boosting may be implemented to capture complex relationships in the data and to enhance prediction accuracy. Additionally, reinforcement learning techniques can be applied to allow system 100 to learn optimal policies through iterative feedback, effectively balancing short-term performance with long-term strategic objectives. Overall, the machine-learning model's 169 integration into the adaptive refinement model 168 may enable system 100 to leverage both historical context and current performance data. This dual approach not only facilitates a more accurate and responsive policy 148 generation process but may also ensure that system 100 remains adaptive, continuously refining its operational strategies in line with the evolving operational environment.

Still referring to FIG. 1, in an embodiment, adaptive refinement model 168 may include a neural network 170, the neural network 170 including an input layer configured to receive time-series data 164, one or more hidden layers configured to process time-series data 164 and extract features, and an output layer configure to output an updated policy 148, wherein the updated policy 148 is used to adjust predetermined progression schedule 160 for activating subsequent modules. The input layer may be configured to receive time-series data 164 that reflects operational performance over time. This data may include user performance metrics, environmental variables, and other relevant operational indicators. The input layer may serve as the first stage of data ingestion, ensuring that raw, sequential data is appropriately formatted and normalized for processing. In some embodiments, preprocessing techniques, such as feature scaling, smoothing, or transformation, are applied at this stage to enhance data quality. One or more hidden layers may be implemented to process the input data and extract meaningful features. These layers may perform complex computations that capture patterns and correlations inherent in the time-series data 164. For example, the hidden layers might employ convolutional or recurrent architectures to detect trends, seasonality, or anomalies in operational performance. In some embodiments, each hidden layer may apply non-linear activation functions, such as ReLU, sigmoid, or tanh, to model the complex relationships between variables. Additionally, techniques such as dropout or batch normalization may be used within these layers to prevent overfitting and improve the model's generalizability. The features extracted by the hidden layers may provide a condensed representation of the input data that captures the critical insights necessary for updating the policy 148. The output layer may be designed to generate an updated policy 148 based on the features extracted by the hidden layers. This updated policy 148 may include specific adjustments to the predetermined progression schedule 160 for activating subsequent modules within the modular suite 156. In one embodiment, the output layer may produce new operational parameters, such as revised performance thresholds or modified time intervals, that redefine the conditions under which additional modules are activated. This adaptive output may then be fed back into system 100, enabling continuous optimization of the operational strategies in response to evolving performance metrics. By integrating the updated policy 148 with the predetermined progression schedule 160, system 100 may ensure that subsequent modules are activated only when current operational performance meets the refined criteria. This continuous feedback loop may enable system 100 to balance resource allocation, maintain operational efficiency, and adapt dynamically to changes in user performance or environmental conditions. The neural network 170 within the adaptive refinement model 168 thus may play a critical role in transforming raw time-series data 164 into actionable policy 148 updates that fine-tune the progression schedule, thereby optimizing overall performance and ensuring alignment with the target function.

In further reference to FIG. 1, in an embodiment, at least a processor 108 may be further configured to instantiate a web-crawler 172 configured to access one or more data sources 174 as a function of environment selection 136, retrieve real-time web-based data 180 relating to environment selection 136, and transmit the real-time web-based data 180 to adaptive refinement model 168, wherein real-time web-based data 180 is integrated into time-series data 164 for further iterative policy 148 refinement. For purposes of this disclosure, a “web-crawler” is an agent designed to automatically access, retrieve, and index information from one or more web-based data sources. In an embodiment, web-crawler 172 may systematically navigate through websites or online databases, collecting data that is relevant to the operational context defined by environment selection 136. For example, if environment selection 136 pertains to a particular industry or geographic region, web-crawler 172 may target websites, news outlets, regulatory databases, and other relevant online resources that provide real-time information on market trends, policy 148 updates, or emerging operational conditions. This collected information may then be processed and integrated with other data sources to enhance system functionality, such as refining policies or updating performance metrics. Once web-crawler 172 retrieves real-time web-based data 180, the data may be transmitted to adaptive refinement model 168. In one embodiment, this transmission may occur continuously or at predetermined intervals, ensuring that adaptive refinement model 168 receives the most current data available. The real-time web-based data 180 may then be integrated into the existing time-series data 164 that system 100 uses to monitor and refine its operational policies. This integration may enable adaptive refinement model 168 to leverage up-to-date external information, further iterating and optimizing policy 148 in light of current trends and changes in the operational environment. Through this approach, system 100 not only relies on internally captured performance data but also benefits from external, real-time inputs. This dual-source data strategy may allow for a more comprehensive and adaptive refinement of policy 148, ensuring that subsequent module activations and adjustments to the progression schedule are informed by a broad spectrum of current and relevant operational data 192a.

In further reference to FIG. 1, in an embodiment, system 100 may further include a data management component 144 configured to organize time-series data 164 and associated performance metrics for subsequent analysis and policy 148 refinement. In an embodiment, data management component 144 may aggregate, and store time-series data 164 collected from various sources, including user interactions, system logs, and external data feeds, into a centralized database or distributed data repository. This data may be indexed and tagged with metadata such as timestamps, identifiers, and contextual information related to the environment selection 136 and operational performance. In another embodiment, data management component 144 may utilize advanced indexing techniques, such as hierarchical or multi-dimensional indexing, to ensure efficient retrieval and querying of the data. This may enable system 100 to quickly access subsets of data for real-time analysis and historical trend evaluation. In an embodiment, data management component 144 may also implement data normalization and standardization processes to reconcile data formats originating from diverse sources, ensuring consistency across the aggregated dataset. Additionally, the organized data may be structured to facilitate the integration of performance metrics with the time-series data 164. This enables adaptive refinement model 168 to conduct comprehensive analyses, such as trend detection, anomaly identification, and performance benchmarking, over both short-term and long-term periods. The resulting insights from these analyses may then be used to iteratively refine the system's operational policy 148 and adjust the predetermined progression schedule 160 for activating subsequent modules. Overall, data management component 144 may play a critical role in enabling robust system performance by ensuring that all relevant data is systematically organized, accessible, and primed for further analysis and policy 148 optimization.

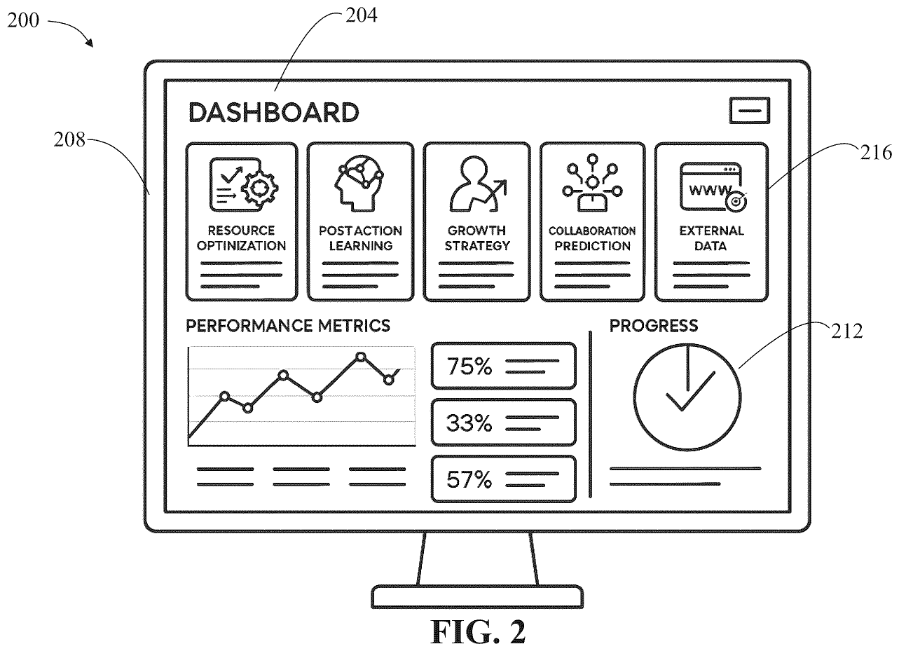

Now referring to FIG. 2, illustrated is an exemplary user interface 200. In an embodiment, user interface 200 may include a dashboard 204 displayed on a display device 208. Dashboard 204 may be configured to present a graphical overview of the status, functionality, and output of modular suite. In some embodiments, dashboard 204 may display a plurality of visual elements 212, each representing different performance metrics, data flows, and system analytics derived from the activated modules. In an embodiment, dashboard 204 may include an interactive map component configured to visualize global or regional data corresponding to environment selection. For example, the map may be used to represent the entity's operational footprint, market demand concentrations, or collaboration opportunities identified by the third module. In some cases, the map may dynamically update based on data received from web crawler or real-time web-based data.

Further, dashboard 204 may include performance indicators such as module activation status, progress bars reflecting progress toward target function, resource distribution summaries, and a module stack indicator showing which of the one or more modules have been activated according to predetermined progression schedule. In an embodiment, interactive icons 216 may represent components such as: time-series analysis derived from time-series data, resource utilization and optimization indicators based on optimized apportionment data, growth readiness based on growth constraint profile, and exploitation insights driven by exploitation data and collaboration data. Each icon may serve as an entry point into deeper analytic views or modification interfaces. For instance, selecting the resource distribution interactive icon 216 may allow users to view or modify apportionment strategies or compare actual performance against model predictions.

In some embodiments, dashboard 204 may further include an alert or notification area configured to inform the user when performance thresholds or time-based criteria have been met, triggering the activation of subsequent modules or prompting intervention. Additionally, visualizations of user experience data and learning datum may be included, showing how post-action insights have influenced resource reallocation, future process output targeting, or entity classification. The user interface 200 and dashboard 204 may be implemented using standard web technologies or rendered through a dedicated application, and may be configured to receive user input via touch, mouse, voice, or other input modalities.

Referring now to FIG. 3, an exemplary embodiment of a machine-learning module 300 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 304 to generate an algorithm instantiated in hardware or software logic, data structures, and/or functions that will be performed by a computing device/module to produce outputs 308 given data provided as inputs 312; this is in contrast to a non-machine learning software program where the commands to be executed are determined in advance by a user and written in a programming language.

Still referring to FIG. 3, “training data,” as used herein, is data containing correlations that a machine-learning process may use to model relationships between two or more categories of data elements. For instance, and without limitation, training data 304 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 304 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 304 according to various correlations; correlations may indicate causative and/or predictive links between categories of data elements, which may be modeled as relationships such as mathematical relationships by machine-learning processes as described in further detail below. Training data 304 may be formatted and/or organized by categories of data elements, for instance by associating data elements with one or more descriptors corresponding to categories of data elements. As a non-limiting example, training data 304 may include data entered in standardized forms by persons or processes, such that entry of a given data element in a given field in a form may be mapped to one or more descriptors of categories. Elements in training data 304 may be linked to descriptors of categories by tags, tokens, or other data elements; for instance, and without limitation, training data 304 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 3, training data 304 may include one or more elements that are not categorized; that is, training data 304 may not be formatted or contain descriptors for some elements of data. Machine-learning algorithms and/or other processes may sort training data 304 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 304 to be made applicable for two or more distinct machine-learning algorithms as described in further detail below. Training data 304 used by machine-learning module 300 may correlate any input data as described in this disclosure to any output data as described in this disclosure. As a non-limiting illustrative example inputs may include a user input such as environment selection or target function. Whereas outputs may include a policy.

Further referring to FIG. 3, training data may be filtered, sorted, and/or selected using one or more supervised and/or unsupervised machine-learning processes and/or models as described in further detail below; such models may include without limitation a training data classifier 316. Training data classifier 316 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 300 may generate a classifier using a classification algorithm, defined as a processes whereby a computing device and/or any module and/or component operating thereon derives a classifier from training data 304. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 316 may classify elements of training data to cohorts associated with specific user input such as environment selection and target function.

Still referring to FIG. 3, a computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)=P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. A computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 3, a computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 3, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 3, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. A computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 3, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 3, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 3, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 3, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 3, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 3, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 3, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset Xₘₐₓ:

$${X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a a set or subset X_{median} and/or interquartile range (IQR), which represents the difference between the 25th percentile value and the 50th percentile value (or closest values thereto by a rounding protocol), such as:

$${X}_{new} = \frac{X - {X}_{median}}{I Q R} .$$

Persons skilled in the art, upon reviewing the entirety of this disclosure, will be aware of various alternative or additional approaches that may be used for feature scaling.

Further referring to FIG. 3, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 3, machine-learning module 300 may be configured to perform a lazy-learning process 320 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 304. Heuristic may include selecting some number of highest-ranking associations and/or training data 304 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 3, machine-learning processes as described in this disclosure may be used to generate machine-learning models 324. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 324 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 324 may be generated by creating an artificial neural network, such as a convolutional neural network comprising an input layer of nodes, one or more intermediate layers, and an output layer of nodes. Connections between nodes may be created via the process of “training” the network, in which elements from a training data 304 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 3, machine-learning algorithms may include at least a supervised machine-learning process 328. At least a supervised machine-learning process 328, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include inputs as described above as inputs, outputs as described above as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 304. Persons skilled in the art, upon reviewing the entirety of this disclosure, will be aware of various possible variations of at least a supervised machine-learning process 328 that may be used to determine relation between inputs and outputs. Supervised machine-learning processes may include classification algorithms as defined above.

With further reference to FIG. 3, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 3, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 3, machine learning processes may include at least an unsupervised machine-learning processes 332. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 332 may not require a response variable; unsupervised processes 332 may be used to find interesting patterns and/or inferences between variables, to determine a degree of correlation between two or more variables, or the like.

Still referring to FIG. 3, machine-learning module 300 may be designed and configured to create a machine-learning model 324 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 3, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 3, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 3, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 3, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 3, one or more processes or algorithms described above may be performed by at least a dedicated hardware unit 336. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 336 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 336 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 336 to perform one or more operations described herein, such as evaluation of model and/or algorithm outputs, one-time or iterative updates to parameters, coefficients, weights, and/or biases, and/or any other operations such as vector and/or matrix operations as described in this disclosure.

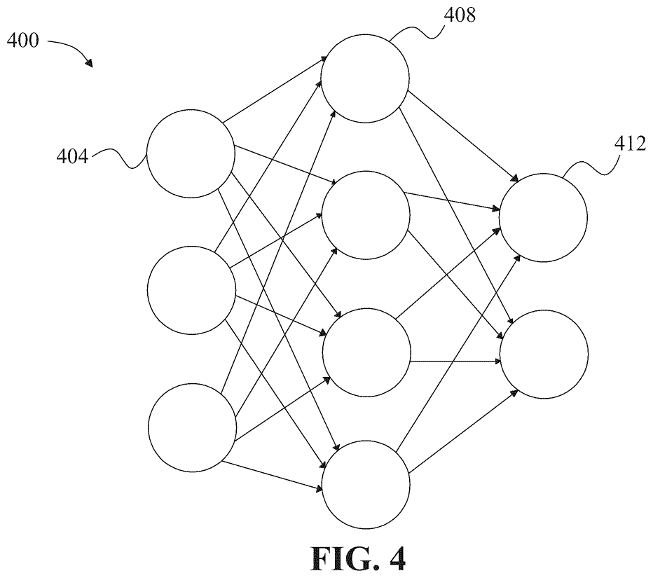

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

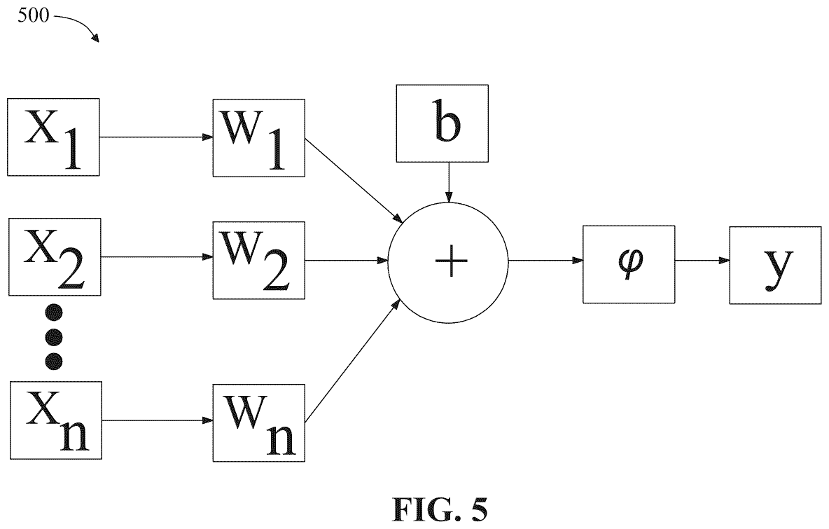

Referring now to FIG. 5, an exemplary embodiment of a node 500 of a neural network is illustrated. A node may include, without limitation a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as ƒ(x)=tanh²(x), a rectified linear unit function such as ƒ(x)=max(0, x), a “leaky” and/or “parametric” rectified linear unit function such as ƒ(x)=max(ax, x) for some a, an exponential linear units function such as

$$f ( x ) = \{ \begin{matrix}x & for x \geq 0 \\ α ( {e}^{x} - 1 ) & for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}} .$$

where the inputs to an instant layer are xᵢ, a swish function such as ƒ(x)=x*sigmoid (x), a Gaussian error linear unit function such as ƒ(x)=a(1+tanh(\sqrt{2/π}(x+bx^{r}))) for some values of a, b, and r, and/or a scaled exponential linear unit function such as

$$f ( x ) = λ \{ \begin{matrix}α ( {e}^{x} - 1 ) & for x < 0 \\ x & for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally, or alternatively, a bias b may be added to the weighted sum of the inputs such that an offset is added to each unit in the neural network layer that is independent of the input to the layer. The weighted sum may then be input into a function p, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

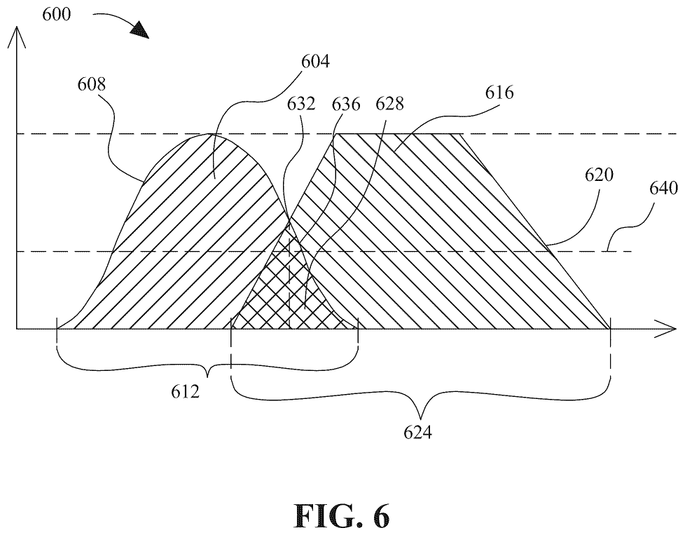

Referring to FIG. 6, an exemplary embodiment of fuzzy set comparison 600 is illustrated. A first fuzzy set 604 may be represented, without limitation, according to a first membership function 608 representing a probability that an input falling on a first range of values 612 is a member of the first fuzzy set 604, where the first membership function 608 has values on a range of probabilities such as without limitation the interval [0,1], and an area beneath the first membership function 608 may represent a set of values within first fuzzy set 604. Although first range of values 612 is illustrated for clarity in this exemplary depiction as a range on a single number line or axis, first range of values 612 may be defined on two or more dimensions, representing, for instance, a Cartesian product between a plurality of ranges, curves, axes, spaces, dimensions, or the like. First membership function 608 may include any suitable function mapping first range 612 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , & for x < c and x < a \\ \frac{x - a}{b - a} , & for a \leq x < b \\ \frac{c - x}{c - b} , & if b < x \leq c\end{matrix}$$

a trapezoidal membership function may be defined as:

$$y ( x , a , b , c , d ) = max ( min ( \frac{x - a}{b - a} , L \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 6, first fuzzy set 604 may represent any value or combination of values as described above, including output from one or more machine-learning models, entity data, growth factor, transport data, manufacturing data, operational data related to an entity, and a predetermined class, such as without limitation of target classification category A second fuzzy set 616, which may represent any value which may be represented by first fuzzy set 604, may be defined by a second membership function 620 on a second range 624; second range 624 may be identical and/or overlap with first range 612 and/or may be combined with first range via Cartesian product or the like to generate a mapping permitting evaluation overlap of first fuzzy set 604 and second fuzzy set 616. Where first fuzzy set 604 and second fuzzy set 616 have a region 628 that overlaps, first membership function 608 and second membership function 620 may intersect at a point 632 representing a probability, as defined on probability interval, of a match between first fuzzy set 604 and second fuzzy set 616. Alternatively, or additionally, a single value of first and/or second fuzzy set may be located at a locus 636 on first range 612 and/or second range 624, where a probability of membership may be taken by evaluation of first membership function 608 and/or second membership function 620 at that range point. A probability at 628 and/or 632 may be compared to a threshold 640 to determine whether a positive match is indicated. Threshold 640 may, in a non-limiting example, represent a degree of match between first fuzzy set 604 and second fuzzy set 616, and/or single values therein with each other or with either set, which is sufficient for purposes of the matching process; for instance, threshold may indicate a sufficient degree of overlap between an output from one or more machine-learning models and/or entity data, growth factor, transport data, manufacturing data, or operational data related to an entity, and a predetermined class, such as without limitation target classification category categorization, for combination to occur as described above. Alternatively, or additionally, each threshold may be tuned by a machine-learning and/or statistical process, for instance and without limitation as described in further detail below.

Further referring to FIG. 6, in an embodiment, a degree of match between fuzzy sets may be used to classify an entity data, growth factor, transport data, manufacturing data, or operational data related to an entity, with target classification category. For instance, if a target classification category has a fuzzy set matching entity data, growth factor, transport data, manufacturing data, or operational data related to an entity, fuzzy set by having a degree of overlap exceeding a threshold, computing device 104 may classify the entity data, growth factor, transport data, manufacturing data, or operational data related to an entity, as belonging to the target classification category categorization. Where multiple fuzzy matches are performed, degrees of match for each respective fuzzy set may be computed and aggregated through, for instance, addition, averaging, or the like, to determine an overall degree of match.

Still referring to FIG. 6, in an embodiment, an entity data, growth factor, transport data, manufacturing data, or operational data related to an entity, may be compared to multiple target classification category categorization fuzzy sets. For instance, entity data, growth factor, transport data, manufacturing data, or operational data related to an entity, may be represented by a fuzzy set that is compared to each of the multiple target classification category categorization fuzzy sets; and a degree of overlap exceeding a threshold between the entity data, growth factor, transport data, manufacturing data, or operational data related to an entity, fuzzy set and any of the multiple target classification category categorization fuzzy sets may cause computing device 104 to classify the entity data, growth factor, transport data, manufacturing data, or operational data related to an entity, as belonging to target classification category categorization. For instance, in one embodiment, there may be two fuzzy sets representing distinct target classification categories, such as a first target category and a second target category. First target classification category categorization may have a first fuzzy set; Second target classification category categorization may have a second fuzzy set; and entity data, growth factor, transport data, manufacturing data, or operational data related to an entity, may have an entity data, growth factor, transport data, manufacturing data, or operational data related to an entity, fuzzy set. computing device 104, for example, may compare an entity data, growth factor, transport data, manufacturing data, or operational data related to an entity, fuzzy set with each of target classification category categorization fuzzy set and in target classification category categorization fuzzy set, as described above, and classify a entity data, growth factor, transport data, manufacturing data, or operational data related to an entity, to either, both, or neither of target classification category categorization or in target classification category categorization. Machine-learning methods as described throughout may, in a non-limiting example, generate coefficients used in fuzzy set equations as described above, such as without limitation x, c, and σ of a Gaussian set as described above, as outputs of machine-learning methods. Likewise, entity data, growth factor, transport data, manufacturing data, or operational data related to an entity, may be used indirectly to determine a fuzzy set, as entity data, growth factor, transport data, manufacturing data, or operational data related to an entity, fuzzy set may be derived from outputs of one or more machine-learning models that take the entity data, growth factor, transport data, manufacturing data, or operational data related to an entity, directly or indirectly as inputs.

Still referring to FIG. 6, a computing device may use a logic comparison program, such as, but not limited to, a fuzzy logic model to determine a target classification category response. An target classification category response may include, but is not limited to, amateur, average, knowledgeable, superior, and the like; each such target classification category response may be represented as a value for a linguistic variable representing target classification category response or in other words a fuzzy set as described above that corresponds to a degree of utilization, efficiency, and/or the like as calculated using any statistical, machine-learning, or other method that may occur to a person skilled in the art upon reviewing the entirety of this disclosure. In other words, a given element of entity data, growth factor, transport data, manufacturing data, or operational data related to an entity, may have a first non-zero value for membership in a first linguistic variable value such as “assignable” and a second non-zero value for membership in a second linguistic variable value such as “non-assignable.” In some embodiments, determining a target classification categorization may include using a linear regression model. A linear regression model may include a machine learning model. A linear regression model may be configured to map data of entity data, growth factor, transport data, manufacturing data, or operational data related to an entity, such as degree of . . . to one or more target classification category parameters. A linear regression model may be trained using a machine learning process. A linear regression model may map statistics such as, but not limited to, quality of entity data, growth factor, transport data, manufacturing data, or operational data related to an entity, In some embodiments, determining a target classification category of entity data, growth factor, transport data, manufacturing data, or operational data related to an entity, may include using a target classification category classification model. A target classification category classification model may be configured to input collected data and cluster data to a centroid based on, but not limited to, frequency of appearance, linguistic indicators of quality, and the like. Centroids may include scores assigned to them such that quality of entity data, growth factor, transport data, manufacturing data, or operational data related to an entity, may each be assigned a score. In some embodiments target classification category classification model may include a K-means clustering model. In some embodiments, target classification category classification model may include a particle swarm optimization model. In some embodiments, determining the target classification category of an entity data, growth factor, transport data, manufacturing data, or operational data related to an entity, may include using a fuzzy inference engine. A fuzzy inference engine may be configured to map one or more entity data, growth factor, transport data, manufacturing data, or operational data related to an entity, data elements using fuzzy logic. In some embodiments, entity data, growth factor, transport data, manufacturing data, or operational data related to an entity, may be arranged by a logic comparison program into target classification category arrangement. An “target classification category arrangement” as used in this disclosure is any grouping of objects and/or data based on skill level and/or output score. This step may be implemented as described above in FIGS. 1-5. Membership function coefficients and/or constants as described above may be tuned according to classification and/or clustering algorithms. For instance, and without limitation, a clustering algorithm may determine a Gaussian or other distribution of questions about a centroid corresponding to a given level, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Further referring to FIG. 6, an inference engine may be implemented according to input and/or output membership functions and/or linguistic variables. For instance, a first linguistic variable may represent a first measurable value pertaining to entity data, growth factor, transport data, manufacturing data, or operational data related to an entity, such as a degree of an element, while a second membership function may indicate a degree of in target classification category of a subject thereof, or another measurable value pertaining to entity data, growth factor, transport data, manufacturing data, or operational data related to an entity. Continuing the example, an output linguistic variable may represent, without limitation, a score value. An inference engine may combine rules, such as: “If operational capacity is high and demand alignment is strong, then collaboration readiness score is excellent”—the degree to which a given input function membership matches a given rule may be determined by a triangular norm or “T-norm” of the rule or output membership function with the input membership function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥,” such as max (a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively, or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively, or additionally, output rules may be replaced with functions according to the Takagi-Sugeno-King (TSK) fuzzy model.

Further referring to FIG. 6, entity data, growth factor, transport data, manufacturing data, or operational data related to an entity, to be used may be selected by user selection, and/or by selection of a distribution of output scores, such as 60% categorized as hard/expert, 40% as moderate/competent, and 60% as easy/beginner, or similar tiered distributions based on user proficiency, task difficulty, or classification output derived from user experience data and learning datum or the like. Each target classification category categorization may be selected using an additional function such as in target classification category as described above.

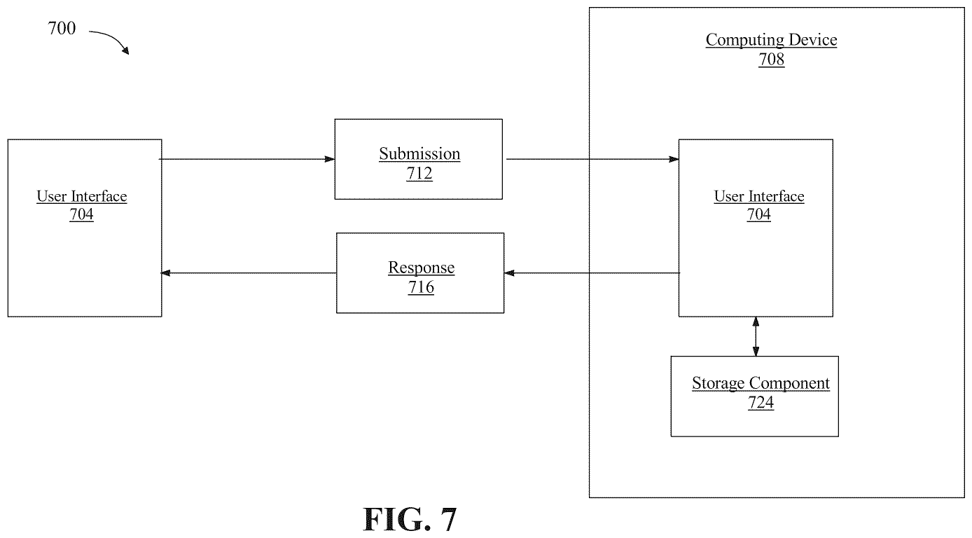

Referring to FIG. 7, a chatbot system 700 is schematically illustrated. According to some embodiments, a user interface 704 may be communicative with a computing device 708 that is configured to operate a chatbot. In some cases, user interface 704 may be local to computing device 708. Alternatively, or additionally, in some cases, user interface 704 may remote to computing device 708 and communicative with the computing device 708, by way of one or more networks, such as without limitation the internet. Alternatively, or additionally, user interface 704 may communicate with user device using telephonic devices and networks, such as fax machines, short message service (SMS), or multimedia message service (MMS). Commonly, user interface 704 communicates with computing device 708 using text-based communication, for example without limitation using a character encoding protocol, such as American Standard for Information Interchange (ASCII). Typically, a user interface 704 conversationally interfaces a chatbot, by way of at least a submission 712, from the user interface 704 to the chatbot, and a response 716, from the chatbot to the user interface 704. In many cases, one or both of submission 712 and response 716 are text-based communication. Alternatively or additionally, in some cases, one or both of submission 712 and response 716 are audio-based communication.

Continuing in reference to FIG. 7, a submission 712 once received by computing device 708 operating a chatbot, may be processed by a processor. In some embodiments, processor processes a submission 712 using one or more of keyword recognition, pattern matching, and natural language processing. In some embodiments, processor employs real-time learning with evolutionary algorithms. In some cases, processor may retrieve a pre-prepared response from at least a storage component 724, based upon submission 712. Alternatively or additionally, in some embodiments, processor communicates a response 716 without first receiving a submission 712, thereby initiating conversation. In some cases, processor communicates an inquiry to user interface 704; and the processor is configured to process an answer to the inquiry in a following submission 712 from the user interface 704. In some cases, an answer to an inquiry present within a submission 712 from a user device may be used by computing device 104 as an input to another function, for example without limitation at least a user input may be integrated into entity profile.

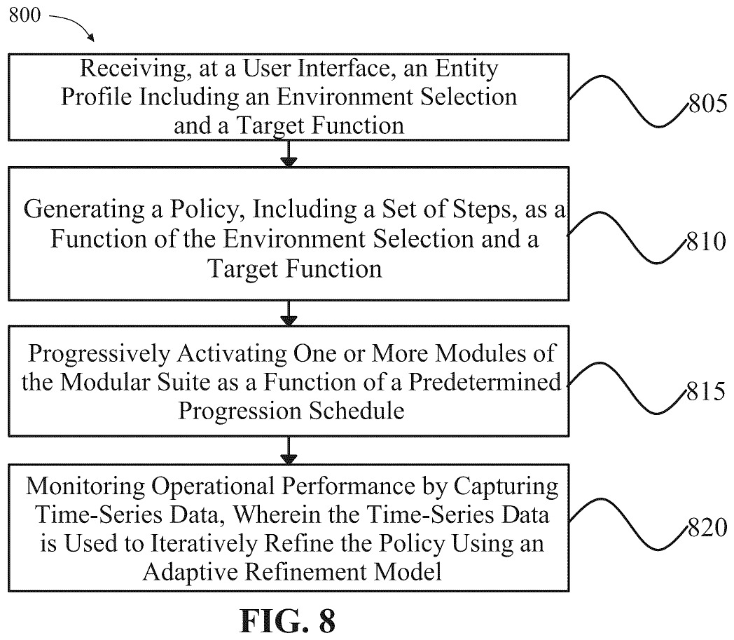

Referring now to FIG. 8, an exemplary method 800 for progressive activation of a modular suite is illustrated. Method 800 may include a step 805 of receiving, from a user interface, a user input comprising an environment selection and a target function. In an embodiment, user input may further include additional parameters including user preferences, entity performance metrics, and environmental variables. In some cases, the adaptive refinement model may use additional parameters to enhance accuracy of policy generation and progressive module activation. This may be implemented, without limitation, as referenced in FIGS. 1-7.

In further reference to FIG. 8, method 800 may include a step 810 of generating a policy, comprising a set of steps, as a function of environment selection and target function. This may be implemented, without limitation, as referenced in FIGS. 1-7.

In continued reference to FIG. 8, method 800 may include a step 815 progressively activating one or more modules of the modular suite as a function of a predetermined progression schedule. In an embodiment, the predetermined progression schedule may be progressed as a function of a set of performance thresholds and time-based criteria, such that activation of subsequent modules is implemented when the time-series data meets or exceeds predefined metrics. In an embodiment, the modular suite may include a first module configured to determine a resource distribution, a second module configured to determine a growth factor, and a third module configured to generate exploitation data. This may be implemented, without limitation, as referenced in FIGS. 1-7.

With continued reference to FIG. 8, method 800 may include a step 820 of monitoring operational performance by capturing time-series data, wherein the time-series data is used to iteratively refine the policy using an adaptive refinement model. In an embodiment, the adaptive refinement model may be further configured to receive operational performance data from multiple users operating within environment selection, compare the user's operational performance data to the performance data from multiple users operating within environment selection, and generate a recommendation that enables user to differentiate and enhance a user's positioning within environment selection. In an embodiment, generating a recommendation may include employing a multi-layer analysis engine. Multi-layer analysis engine may include a data aggregation module configured to normalize and consolidate operational performance data, a feature extraction module configured to identify key performance metrics and extract salient features from the normalized data, and a recommendation module configured to apply a neural network-based decision model to compare user's performance against aggregated operational performance data. In an embodiment, adaptive refinement model may include a machine-learning model trained on historical and real-time operational data. In an embodiment, adaptive refinement model may include a neural network, the neural network including an input layer configured to receive time-series data, one or more hidden layers configured to process time-series data and extract features, and an output layer configure to output an updated policy, wherein the updated policy is used to adjust predetermined progression schedule for activating subsequent modules. This may be implemented, without limitation, as referenced in FIGS. 1-7

In further reference to FIG. 8, method 800 may further include a step of instantiating a web-crawler configured to access one or more data sources as a function of environment selection, retrieve real-time web-based data relating to environment selection, and transmit the real-time web-based data to adaptive refinement model, wherein real-time web-based data is integrated into time-series data for further iterative policy refinement. This may be implemented, without limitation, as referenced in FIGS. 1-7

In continued reference to FIG. 8, method 800 may further include a step of organizing, using a data management component, the time-series data and associated performance metrics for subsequent analysis and policy refinement. This may be implemented, without limitation, as referenced in FIGS. 1-7

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

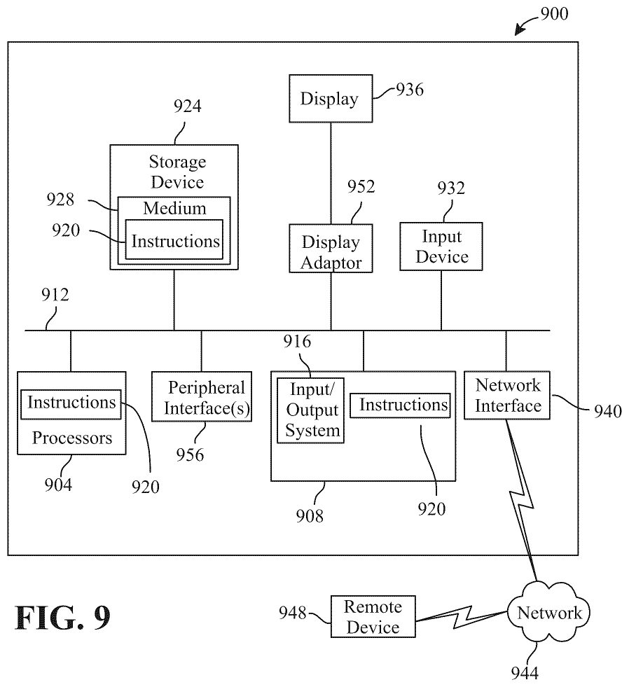

FIG. 9 shows a diagrammatic representation of one embodiment of a computing device in the exemplary form of a computer system 900 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 900 includes a processor 904 and a memory 908 that communicate with each other, and with other components, via a bus 912. Bus 912 may include any of several types of bus structures including, but not limited to, a memory bus, a memory controller, a peripheral bus, a local bus, and any combinations thereof, using any of a variety of bus architectures.

Processor 904 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 904 may be organized according to Von Neumann and/or Harvard architecture as a non-limiting example. Processor 904 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 908 may include various components (e.g., machine-readable media) including, but not limited to, a random-access memory component, a read only component, and any combinations thereof. In one example, a basic input/output system 916 (BIOS), including basic routines that help to transfer information between elements within computer system 900, such as during start-up, may be stored in memory 908. Memory 908 may also include (e.g., stored on one or more machine-readable media) instructions (e.g., software) 920 embodying any one or more of the aspects and/or methodologies of the present disclosure. In another example, memory 908 may further include any number of program modules including, but not limited to, an operating system, one or more application programs, other program modules, program data, and any combinations thereof.

Computer system 900 may also include a storage device 924. Examples of a storage device (e.g., storage device 924) include, but are not limited to, a hard disk drive, a magnetic disk drive, an optical disc drive in combination with an optical medium, a solid-state memory device, and any combinations thereof. Storage device 924 may be connected to bus 912 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 924 (or one or more components thereof) may be removably interfaced with computer system 900 (e.g., via an external port connector (not shown)). Particularly, storage device 924 and an associated machine-readable medium 928 may provide nonvolatile and/or volatile storage of machine-readable instructions, data structures, program modules, and/or other data for computer system 900. In one example, software 920 may reside, completely or partially, within machine-readable medium 928. In another example, software 920 may reside, completely or partially, within processor 904.

Computer system 900 may also include an input device 932. In one example, a user of computer system 900 may enter commands and/or other information into computer system 900 via input device 932. Examples of an input device 932 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 932 may be interfaced to bus 912 via any of a variety of interfaces (not shown) including, but not limited to, a serial interface, a parallel interface, a game port, a USB interface, a FIREWIRE interface, a direct interface to bus 912, and any combinations thereof. Input device 932 may include a touch screen interface that may be a part of or separate from display 936, discussed further below. Input device 932 may be utilized as a user selection device for selecting one or more graphical representations in a graphical interface as described above.

A user may also input commands and/or other information to computer system 900 via storage device 924 (e.g., a removable disk drive, a flash drive, etc.) and/or network interface device 940. A network interface device, such as network interface device 940, may be utilized for connecting computer system 900 to one or more of a variety of networks, such as network 944, and one or more remote devices 948 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 944, may employ a wired and/or a wireless mode of communication. In general, any network topology may be used. Information (e.g., data, software 920, etc.) may be communicated to and/or from computer system 900 via network interface device 940.

Computer system 900 may further include a video display adapter 952 for communicating a displayable image to a display device, such as display device 936. Examples of a display device include, but are not limited to, a liquid crystal display (LCD), a cathode ray tube (CRT), a plasma display, a light emitting diode (LED) display, and any combinations thereof. Display adapter 952 and display device 936 may be utilized in combination with processor 904 to provide graphical representations of aspects of the present disclosure. In addition to a display device, computer system 900 may include one or more other peripheral output devices including, but not limited to, an audio speaker, a printer, and any combinations thereof. Such peripheral output devices may be connected to bus 912 via a peripheral interface 956. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A system for progressive activation of a modular suite, the system comprising:
a user interface configured to receive user input;
at least a processor;
a first module within the modular suite and operating on the at least a processor, wherein the first module is configured determine a resource distribution by:
identifying a plurality of resource data as a function of an entity profile, wherein the plurality of resource data comprises at least one workflow efficiency metric;
determining apportionment data as a function of the plurality of resource data;
generating optimized apportionment data as a function of the apportionment data and the plurality of resource data, wherein generating the optimized apportionment data comprises:
identifying at least one constraint associated with the apportionment data using a constraint machine-learning model that has been trained on a dataset comprising apportionment data correlated to historical constraints; and
determining a resource distribution as a function of the optimized apportionment data, wherein the resource distribution allocates at least one of monetary resources, time, equipment, and personnel;
a second module within the modular suite operating on the at least a processor and communicatively connected to the first module, wherein the second module is configured to determine a growth factor by:
receiving an output from the first module, wherein the output comprises the resource distribution; and
determining a growth constraint profile comprising at least one characteristic affecting a growth ability of an entity associated with the entity profile and a temporal element;
a third module within the modular suite operating on the at least a processor and communicatively connected to the second module, wherein the third module is configured to generate exploitation data by:
receiving a plurality of entity profiles, each comprising operational data;
identifying demand data as a function of the plurality of entity profiles;
generating exploitation data as a function of the operational data and the demand data of the plurality of entity profiles; and
determining collaboration data as a function of the exploitation data; and
a memory communicatively connected to the at least a processor, wherein the memory contains instructions configuring the at least a processor to:
receive, at the user interface, an entity profile comprising an environment selection and a target function;
generate a policy, comprising a set of steps, as a function of the environment selection and the target function;
generate a progression schedule based on the policy, wherein the progression schedule specifies activation conditions for each of a plurality of modules of the modular suite, wherein the activation conditions comprise:
a set of performance thresholds, one performance threshold being related to efficiency gains; and
a time-based criteria, wherein the time-based criteria comprise a scheduled duration requiring at least a module of the plurality of modules to remain active up to at least one year before activation of a subsequent module; and
progressively activate the plurality of modules of the modular suite as a function of the progression schedule by:
selectively initiating each module of the plurality of modules based on its relevance to a current operational context defined by the policy;
monitoring one or more performance metrics of the system to determine satisfaction of activation conditions associated with each module of the plurality of modules, wherein monitoring the one or more performance metrics comprises:
capturing, by the at least a processor, time-series data for the one or more performance metrics, and wherein the one or more performance metrics comprise at least a workflow efficiency gain;
generating a temporal performance representation as a function of the time-series data; and
evaluating the temporal performance representation as a function of the time-series data; and
allocating computational and interface resources, including processor time and memory allocation, only to modules of the modular suite whose activation conditions are satisfied in order to optimize resource allocation, wherein a subsequent module is activated when the temporal performance representation satisfies the set of performance thresholds, and the time-based criteria are satisfied, thereby reducing unnecessary computational execution of inactive modules and improving processing efficiency of the system.

2. (canceled)

3. The system of claim 1, wherein the at least a processor is further configured to iteratively refine the policy using an adaptive refinement model, wherein the adaptive refinement model comprises a machine-learning model that has been trained on historical and real-time operational data.

4. The system of claim 1, wherein determining a resource distribution further comprises predicting a breakaway point as a function of the optimized apportionment data using a breakaway machine-learning model that has been trained using breakaway training data, wherein the breakaway point determines a point in time the target function of an entity will be achieved.

5. The system of claim 1, wherein determining a resource distribution as a function of the optimized apportionment data further comprises determining a resource distribution as a function of a breakaway point using a distribution machine-learning model that has been trained on data comprising the optimized apportionment data correlated and the breakaway point correlated to a plurality of resource distributions.

6. The system of claim 1, wherein:
the first module is further configured to determine at least one future process output as a function of the entity profile; and
determining the resource distribution further comprises:
classifying the entity profile into one or more objective groups using an objective group classifier;
predicting the at least one future process output using a future process output alignment machine-learning model that has been trained on historical entity profiles and process outputs; and
adjusting the apportionment data as a function of the at least one future process output and the one or more objective groups.

7. The system of claim 1, wherein, the first module is further configured to implement a post-action function, wherein implementing a post-action function comprises:
receiving user experience data associated with the entity;
identifying at least one learning datum as a function of the user experience data;
modifying the optimized apportionment data using a post-action machine-learning model configured to receive the at least one learning datum as input.

8. The system of claim 1, wherein the at least a processor is further configured to instantiate a web-crawler configured to:
access one or more data sources as a function of the environment selection;
retrieve real-time web-based data relating to the environment selection; and
transmit the real-time web-based data to the third module, wherein the real-time web-based data is integrated into time-series data for further iterative policy refinement.

9. The system of claim 1, wherein generating exploitation data further comprises using an exploitation machine-learning model that has been trained with a plurality of data entries containing operational data inputs correlated to exploitation data outputs.

10. The system of claim 1, wherein the user interface further comprises a dashboard that displays a current status of module activation, performance metrics, and progress toward the target function.

11. A method for progressive activation of a modular suite, the method comprising:
receiving, at a user interface operating on at least a processor, an entity profile comprising an environment selection and a target function;
generating a policy, comprising a set of steps, as a function of the environment selection and the target function;
generating a progression schedule based on the policy, wherein the progression schedule specifies activation conditions for each of a plurality of modules of a modular suite wherein the activation conditions comprise:
a set of performance thresholds, one performance threshold being related to efficiency gains; and
a time-based criteria, wherein the time-based criteria comprise a scheduled duration requiring at least a module of the plurality of modules to remain active up to at least one year before activation of a subsequent module;
progressively activating the plurality of modules of the modular suite as a function of a progression schedule by:
selectively initiating each module of the plurality of modules based on its relevance to a current operational context defined by the policy;
monitoring one or more performance metrics associated with the modular suite to determine satisfaction of activation conditions associated with each module of the plurality of modules, wherein monitoring the one or more performance metrics comprises;
capturing, by the at least a processor, time-series data for the one or more performance metrics, and wherein the one or more performance metrics comprise at least a workflow efficiency gain;
generating a temporal performance representation as a function of the time-series data; and
evaluating the temporal performance representation as a function of the time-series data; and
allocating computational and interface resources, including processor time and memory allocation, only to modules of the modular suite whose activation conditions are satisfied in order to optimize resource allocation, wherein a subsequent module is activated when the temporal performance representation satisfies the set of performance thresholds, and the time-based criteria are satisfied, thereby reducing unnecessary computational execution of inactive modules and improving processing efficiency; and wherein:
a first module within the modular suite and operating on the at least a processor is configured determine a resource distribution by:
identifying a plurality of resource data as a function of the entity profile, wherein the plurality of resource data comprises at least one workflow efficiency metric;
determining apportionment data as a function of the plurality of resource data;
generating optimized apportionment data as a function of the apportionment data and the plurality of resource data, wherein generating the optimized apportionment data comprises:
identifying at least one constraint associated with the apportionment data using a constraint machine-learning model that has been trained on a dataset comprising apportionment data correlated to historical constraints; and
determining a resource distribution as a function of the optimized apportionment data, wherein the resource distribution allocates at least one of monetary resources, time, equipment, and personnel;
a second module within the modular suite and communicatively connected to the first module is configured to determine a growth factor by:
receiving the resource distribution from an output of the first module; and
determining a growth constraint profile comprising at least one characteristic affecting a growth ability of an entity associated with the entity profile and a temporal element; and
a third module within the modular suite and communicatively connected to the second module is configured to generate exploitation data by:
receiving a plurality of entity profiles, each comprising operational data;
identifying demand data as a function of the entity profiles;
generating exploitation data as a function of the operational data and the demand data of the plurality of entity profiles; and
determining collaboration data as a function of the exploitation data.

12. (canceled)

13. The method of claim 11, further comprising iteratively refining the policy using an adaptive refinement model, wherein the adaptive refinement model comprises a machine-learning model that has been trained on historical and real-time operational data.

14. The method of claim 11, wherein determining a resource distribution further comprises predicting a breakaway point as a function of the optimized apportionment data using a breakaway machine-learning model that has been trained using breakaway training data, wherein the breakaway point determines a point in time the target function of an entity will be achieved.

15. The method of claim 11, wherein determining a resource distribution as a function of the optimized apportionment data further comprises determining a resource distribution as a function of a breakaway point using a distribution machine-learning model that has been trained on data comprising the optimized apportionment data and the breakaway point correlated to a plurality of resource distributions.

16. The method of claim 11, further comprising determining, using the first module, at least one future process output as a function of the entity profile; and
wherein, determining the resource distribution further comprises:
classifying the entity profile into one or more objective groups using an objective group classifier;
predicting the at least one future process output using a future process output alignment machine-learning model that has been trained on historical entity profiles and process outputs; and
adjusting the apportionment data as a function of the at least one future process output and the one or more objective groups.

17. The method of claim 11, further comprising implementing a post-action function using the first module, wherein implementing a post-action function comprises:
receiving user experience data associated with the entity;
identifying at least one learning datum as a function of the user experience data;
modifying the optimized apportionment data using a post-action machine-learning model configured to receive the at least one learning datum as input.

18. The method of claim 11, further comprising instantiating a web-crawler configured to:
access one or more data sources as a function of the environment selection;
retrieve real-time web-based data relating to the environment selection; and
transmit the real-time web-based data to the third module, wherein the real-time web-based data is integrated into time-series data for further iterative policy refinement.

19. The method of claim 11, wherein generating exploitation data further comprises using an exploitation machine-learning model that has been trained with a plurality of data entries containing operational data inputs correlated to exploitation data outputs.

20. The method of claim 11, further comprising displaying, at the user interface further comprising a dashboard, a current status of module activation, performance metrics, and progress toward the target function.
